(19) United States
(12) Patent Application Publication
(10) Pub. No.: US 2024/0010083 A1
(43) Pub. Date: Jan. 11, 2024

(54) ELECTRIC VEHICLE CHARGING STATION WITH SAFETY FEATURES

(71) Applicants: Christopher Ian PIRIE, Mukilteo, WA (US); Kevin Bryant INKPEN, Vancouver (CA)

(72) Inventors: Christopher Ian PIRIE, Mukilteo, WA (US); Kevin Bryant INKPEN, Vancouver (CA)

(21) Appl. No.: 18/257,080

(22) PCT Filed: Mar. 16, 2022
(86) PCT No.: PCT/CA2022/050401

§ 371 Date: Jun. 12, 2023

Related U.S. Application Data
(60) Provisional application No. 63/161,814, filed on Mar. 16, 2021.

(51) Int. Cl. B60L 53/18; B60L 53/16; B60L 53/30

(52) U.S. Cl. CPC B60L 53/18; B60L 53/16; B60L 53/30

(57) ABSTRACT

Charging stations for electric vehicles may include arms that extend from a structure to allow easy deployment of a charging plug to a charging receptacle on an electric vehicle. The arms may be pivotally connected to the structure. Charging cables may be attached to the arms by a break away construction. Arms may include mechanical fuses that deform or break when excessive forces are applied to the arms. These features of construction can help to protect the charging station and charging cable from damage. Charging stations may include other features including lighting, motion sensors, cameras, and suspended plug cradles.

### CROSS-REFERENCE TO RELATED APPLICATIONS

This application claims priority from U.S. application No. 63/161,814 filed 16 Mar. 2021 and entitled ELECTRIC VEHICLE CHARGING STATION WITH CABLE MANAGEMENT AND OVERLOAD WARNING MEANS which is hereby incorporated herein by reference for all purposes. For purposes of the United States of America, this application claims the benefit under 35 U.S.C. § 119 of U.S. application No. 63/161,814 filed 16 Mar. 2021 and entitled ELECTRIC VEHICLE CHARGING STATION WITH CABLE MANAGEMENT AND OVERLOAD WARNING MEANS.

### BACKGROUND

The present technology relates to charging systems for electric vehicles (“EV”s) and in particular to apparatus and methods for managing cables for delivering charging current to electric vehicles.

Electric vehicles (EVs), which may be battery electric or plug-in hybrid vehicles of any sort, including personal cars and trucks, commercial and fleet vehicles, industrial equipment (such as forklifts), aircraft, aircraft service vehicles, delivery drones, watercraft, and the like, are typically charged by a charging system configured to deliver electrical charging current to the EV by way of a charging cable.

A typical EV charging system includes an electric power source connected to supply electrical power to an electrical relay and control unit known as Electric Vehicle Supply Equipment (EVSE), which in turn may be connected to charge one or more EVs by one or more charging cables.

A typical EVSE receives signals from an EV indicating when the EV is ready to receive charging current and interprets those signals, then either connects or disconnects the power source to the charging cable connected to the vehicle. An EVSE may also have other functions such as determining charge priority between two or more EVs and switching power on or off to selected EVs accordingly, and indicating the status and energy transfer rate of the charging circuit.

Most currently available EV charging equipment includes a charging cable that lies on the ground while connected between a charging station and an EV. To connect an EV to a charging station a user must typically pull a charging cable connected to the charging station toward the EV and connect the cable to a charging receptacle of the EV. After charging is complete the user may coil and hang the charging cable. Charging cables can be heavy, especially when long and designed to carry high charging currents and can be dirty especially if deployed on the ground.

With ever increasing adoption of EVs for commercial and personal use, ever-increasing numbers of parking spaces will require access to a charging station. Many households already have, or will soon have an EV regularly parked and needing to be charged in their driveways and garages, and many of these households will soon add a second EV.

Suitably locating an EV charging station can be challenging because the charging station needs a source of electrical power, needs to be located reasonably close to an area where an EV may be parked during charging and needs to include a structure suitable for mounting components of the charging station. This problem can be further complicated where it is desired to situate the charging station to allow two or more vehicles to be simultaneously connected for charging. The charging station should be installed in a way that can accommodate different EVs that may have charging receptacles at different locations on the EV as well as different orientations of the EV (e.g. one driver may prefer to back into a charging spot while another may prefer to drive forward into the charging spot).

Accordingly, there is a need for charging stations that include cables that can reach a wide area around the charging stations. Many existing charging stations approach this need by providing long cables, which are meant to be manually stowed at the station (eg. by looping over a hook) when not in use. In use, the cable normally lies on the ground between the station and the vehicle. These stations have the disadvantage of being inconvenient for the user, requiring that the cable (which are typically quite heavy, and may be wet and/or dirty) be coiled up and stowed. In practice, charging cables are frequently left on the ground creating a messy appearance, a tripping hazard, a barrier to mobility-limited users (wheelchair, walking aid, or scooter), and also creating a situation where the cable and plug is at risk of being run over and damaged. This approach is also limited by the maximum cable length of 25 feet currently allowed for many EVSEs.

Some existing charging stations include a mechanical retractor attached via a small diameter tension cable to the larger, heavier charging cable at a point along the charging cable length. The retractor may support a portion of the charging cable up off the ground and close to the station until a user pulls the charging cable away from the station. This approach has the added complexity of a retractor which typically relies on springs, counterweights, or other mechanical means to apply tension to the retractor cable. Also, the length of charging cable that can be controlled and held off the ground is typically limited by the height of the station structure.

Retractor-type cable reels are available that directly spool the charging cable onto a reel until pulled out by the user. Charging cables are typically quite heavy and often have a diameter greater than 0.5 inch, requiring a relatively heavy and complex retractor to stow sufficient length of charging cable. Such charging cable retractor reels suffer the disadvantages of cost, complexity, and weight.

One type of existing charging station, the Tesla ‘Supercharger’, has a short cable that can be more easily stowed within the station, but requires the user to back the vehicle in to within a specific distance of the station (optionally using driving assist features specific to the vehicle and station), and can only accommodate vehicles with the charge receptacle at the left rear of the vehicle. This approach is limited to particular vehicles and parking orientations.

Although modern charging software typically prevents the driver from driving away with the vehicle connected to the charger, there are other situations in which excess tension may be applied to the charging cable, for example becoming tangled with a moving vehicle, rough usage, abuse such as a person climbing or swinging on the cable, or vandalism. Similarly, abuse loads may be applied to part of the charging station other than the cable, for example a person stepping or climbing on the station structure or using the station structure to support weight other than the weight of the charging cable.

U.S. Pat. No. 10,308,122 Rodriguez shows an industrial charging station including a base unit containing electrical supply equipment and an arm through which charging cables pass pivoting about a horizontal pivot axis, with heavy counterbalance weights used to ease operation.

U.S. Pat. No. 8,925,885, Ishii et al. shows an articulated arm with horizontal pivot axes, gravity compensation apparatus, a parallelogram mechanism, and a charging plug directly attached to the end of the last arm segment.

U.S. Pat. No. 8,373,389, Badger shows an articulated overhead arm that positions a charging plug. The arm has swivel joints that provide 6 degrees of freedom between the base and the end of the arm.

U.S. Pat. No. 5,306,999, Hoffman shows charging stations that include a base and articulated arms with parallelogram mechanisms. A charging plug is directly coupled to the last arm segment. Hoffman also shows an embodiment with a vertical tube enclosing a portion of a charging cable, the tube being connected to the base by a coil spring thus allowing the tube to move to a non-vertical position in a conical range when the cable is pulled, and biased to return to the vertical position when the cable is released.

This arrangement has no predetermined force or travel limit, other than the elastic deformation or breaking limits of the components and their attachment means.

US Patent Publication No. US2015/0060611, Takahashi et al. shows a wall-mounted articulated overhead arm having rectangular tube section arms and magnet catches to hold the arms in a stowed position. A charge cable extends through bores extending along the arms. The plug end of the charge cable hangs from a hole in a distal end of the arm.

WO202235319 A1, Van Den Brande et al. shows an overhead arm with a horizontal pivot axis, having a sliding carriage in a vertical base and a support member. This unit folds to a vertical non-functional state.

WO202143897 A1, MacDonald shows a vertically stowing arm having a sliding mechanism.

WO202147762 A1, Tueschen et al. shows a single pivoting arm supporting a charging cable, with a spring or counterweight mechanism biasing the arm to a stowed position. A cable slides through an opening on a distal end of the arm.

The inventors have recognized a need for EV charging stations that include features for improved cable management as well as other enhancements.

### SUMMARY

The present invention has a number of aspects. While these aspects have synergies when combined they also have benefit when applied individually. Without limitation, the present invention includes:
apparatus for managing EV charging cables
methods for managing EV charging cables;
EV charging stations;
systems and methods for protecting EV charging cables and cable management apparatus from damage due to tension in the charging cables;
systems and methods for warning against placing excess weight on a cable support structure;
EV charging stations configured for simple upgrading to charge additional EVs; and
all combinations of any of these with one another.

The present technology has example application in an improved EV charging station that has a base unit attached to a structure and an electrical power source, an arm portion that extends from a support (e.g. the base unit, the structure or another support). The arm carries a charging cable. A portion of the charging cable hangs from a distal end of the arm and terminates at a charging plug. The arm may be mounted to the support via a pivot joint, such that the arm is movable by pivoting around an axis of the pivot joint in a selected range. Example embodiments of the present technology include one or a combination of any two or more of the following features:
The charging cable is releasably attached to the arm by a force limiting mechanism, such that the attachment of the charging cable to the arm is released when more than a threshold amount of force is applied to the charging cable.
A joint includes a mechanical fuse (force limiting means), such that the arm rotates suddenly from a normal use position to another position when if more than a threshold amount of force is applied to the arm is in a selected direction. The joint may be constructed so that the arm must be reset by a user before the arm will stay in the normal use position. This construction advantageously provides both immediate and persisting indication that excess force has been applied to the arm.
The charging station includes a charging plug holder attached to the charging cable at an adjustable location such that the charging plug can be stowed close to the end of the arm.
The charging station includes a control unit (EVSE) attached to the arm, electrically connected between the power source and the charging cable. The EVSE is modular and expandable, including a primary charge circuit configured such that a second charging circuit may be optionally added after the charging station has been installed and in use. The second charging circuit may be modular. The second charging circuit and the EVSE may be configured to allow the second charging circuit to be plugged in to the EVSE.
The arm includes at least one sensor sensing the proximity of a vehicle and/or the proximity of a user, and/or an image.
The arm includes two segments joined at a pivot joint, with an image sensor attached to each segment and the image from one sensor may be related to the other using the known pivot axis location relative to each sensor.
The charging station includes mounting components that are adapted to facilitate a person working alone to attach the charging station, including the arm, to a structure.

One aspect of the present technology provides an electric vehicle charging station, comprising an electrical power supply cable, a control unit connectable to receive electrical power from the power supply cable, a charging plug adapted to connect to an electric vehicle, a charging cable having a proximal end connected to the control unit and a distal end connected to the charging plug, a base portion mountable to a structure, and an arm projecting from the base portion and supporting at least a portion of the charging cable, the arm having a proximal end coupled to the base portion and a distal end spaced apart from the base portion, the electric vehicle charging station further comprising one or more of:
a) a connection of the arm to the base portion configured to suddenly allow the distal end of the arm to drop slightly in response to a moment about the mounting portion that is directed to move the distal end of the arm downward.
b) the charging cable is held to be supported by the arm by one or more members attached to the arm by force-limiting attachments which are configured to separate from the arm if pulled away from the arm by a force exceeding a threshold force;
c) the charging cable is attached to the arm by a fitting having an elastic portion adapted to detach from the arm when a tension load exceeding a selected magnitude is applied to the charging cable between the attachment point and the charging plug;
d) a downward looking camera is located near the distal end of the arm;
e) a charging plug support means is coupled to a free end of the charging cable between the attachment point and the charging plug, wherein the charging plug support means includes an elastic portion engaging the charging cable and a cradle portion adapted to support the charging plug and a portion of the charging cable;
f) the control unit is attached to and supported by the arm;
g) the connection of the arm to the base portion comprises deformable force limiting means adapted to allow the arm to rotate through a limited range of motion in a rotation plane when a bending moment acting in the rotation plane in a selected direction and of at least a selected magnitude is applied to the arm;
h) the arm comprises a proximal arm section connected to a distal arm section by a pivot joint defining a pivot axis and the pivot joint includes a deformable force limiting means adapted to allow the distal arm section to rotate through a limited range in a distal rotation plane when a bending moment acting in the distal rotation plane in a selected direction and of at least a selected magnitude is applied to the distal arm.

Another aspect of the present technology provides a cable assembly useful for electric vehicle charging, The cable assembly comprises an arm comprising a mount configured to attach the arm to a structure such that the arm projects outwardly from the structure. A cable is supported by the arm and has a free end extending from a distal end of the arm. The cable is releasably attached to the arm by a force limiting mechanism. The force limiting mechanism is operative to allow the cable to be separated from the arm in response to tension pulling the free end of the cable in a direction such that a force component in a direction transverse to the arm has a magnitude exceeding a threshold. A plug may be provided at an end of the cable for charging an EV.

In some embodiments the arm is formed with a longitudinally extending channel that has an opening facing outwardly of the arm, the cable extends along the channel, and the force limiting mechanism comprises one or more members that block the cable from being pulled out of the channel through the opening.

In some embodiments the channel extends along a lower surface of the arm.

In some embodiments the force limiting mechanism comprises an elongated panel that covers the opening of the channel.

In some embodiments the one or more members support a light emitting strip that extends along the channel.

In some embodiments the panel is held to the arm by push-in rivets spaced apart along a length of the channel.

In some embodiments the panel comprises laterally-projecting flexible tab portions, the channel includes first and second recesses on opposing sides of the channel and the panel is held to the arm by engagement of the flexible tabs of the panel with the recesses on the opposing sides of the channel.

In some embodiments the force limiting mechanism comprises a breakaway conduit attached to the arm by releasable fasteners configured to allow the breakaway conduit to pull away from the arm in response to the force component acting on the breakaway conduit.

In some embodiments the releasable fasteners are selected from push in rivets or magnets or adhesive pads or hook and loop fasteners.

In some embodiments the threshold is 45 kg force or less.

In some embodiments the arm is coupled to the mount by a coupling that comprises a mechanical fuse, the mechanical fuse configured to deform or break to allow the distal end of the arm to drop to a dropped position in response to a moment caused by downward force on the arm wherein the arm remains in the dropped position until the arm is reset or the mechanical fuse is replaced. In some embodiments in moving from a normal position to the dropped position the distal end of the arm is lowered by no more than 30 centimeters.

In some embodiments the arm remains in the dropped position until the arm is reset or the mechanical fuse is replaced.

In some embodiments the arm is coupled to the mount by a pivot assembly configured to allow the arm to pivot about a substantially vertical axis.

In some embodiments the pivot assembly comprises a bias mechanism connected to bias the arm toward a stowed position.

In some embodiments the arm lies parallel to a face of the structure when the arm is in the stowed position.

In some embodiments the pivot assembly comprises a mechanical fuse, the mechanical fuse configured to deform or break to allow a pivot axis of the pivot assembly to shift from a normal vertical orientation to an inclined orientation in response to a moment caused by downward force on the arm exceeding a threshold moment.

In some embodiments the pivot assembly comprises first and second spaced apart bearings that define the pivot axis wherein the mechanical fuse holds the first bearing in a position such that the pivot axis is vertical and deformation or breaking of the mechanical fuse allows transverse movement of the first bearing relative to the second bearing such that the pivot axis is movable to an angle that is inclined to vertical. In some embodiments the second bearing is a spherical bearing. In some embodiments the first bearing is slidable along a slot that extends transversely relative to the pivot axis and the mechanical fuse comprises a member that blocks the first bearing from sliding along the slot until a compression or tension force on the mechanical fuse exceeds a threshold. In some embodiments the mechanical fuse comprises a deformable circlip.

In some embodiments the pivot assembly is configured so that the pivot axis remains in the inclined position until the arm is reset or the mechanical fuse is replaced.

In some embodiments the cable assembly comprises a mechanical fuse, the mechanical fuse configured to deform or break to allow an angle of the arm relative to a pivot axis of the pivot assembly to shift downward from a normal orientation to a changed orientation in which the distal end of the arm is lowered in response to a moment caused by downward force on the arm exceeding a threshold moment. In some embodiments the mechanical fuse is located between a bearing of the pivot assembly and a support member on the arm and the mechanical fuse is in a line of force transmission between the support member and the bearing. In some embodiments the mechanical fuse is normally in compression and is configured to be reduced in length upon being deformed or broken. In some embodiments the mechanical fuse is normally in tension and is configured to be increased in length upon being deformed or broken.

In some embodiments the cable assembly comprises an electrical switch that is arranged to change state in direct or indirect response to the mechanical fuse deforming or breaking. In some embodiments the electrical switch is connected to control application of charging current through the cable and the change of state of the electrical switch causes the supply of charging current to be interrupted.

In some embodiments the arm comprises at least one intermediate pivot joint configured to allow a distal portion of the arm to be pivoted relative to a proximal portion of the arm. In some embodiments the intermediate pivot joint comprises a mechanical fuse, the mechanical fuse configured to deform or break to allow the distal portion of the arm to move to a dropped position in response to a moment caused by downward force on the distal portion of the arm wherein the distal portion of the arm remains in the dropped position until the distal portion of the arm is reset or the mechanical fuse is replaced.

In some embodiments the cable assembly comprises a charging plug attached to a distal end of the cable.

In some embodiments the cable is a first cable and the cable assembly also comprises a second cable supported by the arm, releasably attached to the arm and having a free end extending from a distal end of the arm.

In some embodiments the second cable is releasably attached to the arm by the force limiting mechanism.

In some embodiments the second cable is releasably attached to the arm by a second force limiting mechanism, the second force limiting mechanism operative to allow the second cable to be separated from the arm in response to tension pulling the distal end of the second cable in a direction such that a force component in a direction transverse to the arm has a magnitude exceeding a second threshold.

In some embodiments the cable assembly comprises Electric Vehicle Supply Equipment (EVSE), mounted to the arm and connected to supply charging current to an electric vehicle by way of the cable. In some embodiments the EVSE is configured to charge one electric vehicle and includes a connector plug for adding a module to charge a second electric vehicle by way of a second cable supported by the arm.

In some embodiments the cable assembly comprises a motion sensor and/or a proximity sensor and/or a camera located on the arm. In some embodiments the motion sensor and/or the proximity sensor is located near a distal end of the arm.

In some embodiments the cable assembly comprises a light and a control circuit operative to turn on the light in response to an output signal from the motion sensor and/or the proximity sensor.

In some embodiments the cable assembly comprises a camera located on the arm at or within 1.2 meters of the distal end of the arm. In some embodiments a wireless data transmitter is connected to transmit image data from the camera to a user.

In some embodiments a charging plug support is coupled to the free end of the cable, the charging plug support comprising a cradle configured to receive and support a plug. The charging plug support may comprise a hook dimensioned to receive and support one or more loops of the cable. In some embodiments the charging plug support is slidably attached to the free end of the cable. In some embodiments the charging plug support comprises a cable receiving portion comprising a plurality of elements that define a bent path for the cable through the cable receiving portion.

Another aspect of the present technology provides a cable assembly useful for electric vehicle charging. The cable assembly comprises an arm, a mount configured to attach the arm to a structure such that the arm projects outwardly from the structure; and a cable supported by the arm and having a free end extending from a distal end of the arm. The arm is coupled to the mount by a coupling that comprises a mechanical fuse, the mechanical fuse configured to deform or break to allow the distal end of the arm to drop to a dropped position in response to a moment caused by downward force on the arm wherein the arm remains in the dropped position until the arm is reset or the mechanical fuse is replaced.

In some embodiments, in moving from a normal position to the dropped position the distal end of the arm is lowered by no more than 15 centimeters.

In some embodiments the arm remains in the dropped position until the arm is reset or the mechanical fuse is replaced.

In some embodiments the arm is coupled to the mount by a pivot assembly configured to allow the arm to pivot about a substantially vertical axis.

In some embodiments the pivot assembly comprises a bias mechanism connected to bias the arm toward a stowed position.

In some embodiments the arm lies parallel to a face of the structure when the arm is in the stowed position.

In some embodiments the pivot assembly comprises a mechanical fuse and the mechanical fuse is configured to deform or break to allow a pivot axis of the pivot assembly to shift from a normal vertical orientation to an inclined orientation in response to a moment caused by downward force on the arm exceeding a threshold moment.

In some embodiments the pivot assembly comprises first and second spaced apart bearings that define the pivot axis wherein the mechanical fuse holds the first bearing in a position such that the pivot axis is vertical and deformation or breaking of the mechanical fuse allows transverse movement of the first bearing relative to the second bearing such that the pivot axis is movable to an angle that is inclined to vertical.

In some embodiments the second bearing is a spherical bearing.

In some embodiments the first bearing is slidable along a slot that extends transversely relative to the pivot axis and the mechanical fuse comprises a member that blocks the first bearing from sliding along the slot until a compression or tension force on the mechanical fuse exceeds a threshold.

In some embodiments the mechanical fuse comprises a deformable circlip.

In some embodiments the cable assembly comprises an electrical switch that is arranged to change state in direct or indirect response to the mechanical fuse deforming or breaking. In some embodiments the electrical switch is connected to control application of charging current through the cable and the change of state of the electrical switch causes the supply of charging current to be interrupted.

Another aspect of the present technology provides apparatus having any new and inventive feature, combination of features, or sub-combination of features as described herein.

Another aspect of the present technology provides methods having any new and inventive steps, acts, combination of steps and/or acts or sub-combination of steps and/or acts as described herein.

Further aspects and example embodiments are illustrated in the accompanying drawings and/or described in the following description.

It is emphasized that the invention relates to all combinations of the above features, even if these are recited in different claims.

### BRIEF DESCRIPTION OF THE DRAWINGS

The accompanying drawings illustrate non-limiting example embodiments of the invention.

FIG. 1A illustrates an embodiment of an example charging station, in a stowed position.

FIG. 1B shows the charging station from FIG. 1A in a deployed position.

FIG. 1C shows a plan view of the charging station from FIG. 1B.

FIG. 2 is an exploded view showing an example pivot joint arrangement.

FIG. 3 is an enlarged view showing an example fixed base portion of a charging station.

FIG. 4 is a side view of the fixed base portion of FIG. 3.

FIG. 5A is a section view taken from FIG. 3, looking downwards.

FIG. 5B is a section taken from FIG. 4.

FIG. 6A is a section view taken from FIG. 4, showing the pivot joint.

FIG. 6B is section view 6A, but showing the pivot joint in an overloaded position.

FIG. 7A is an enlarged detail view showing the cable end plug and hanger clip portion of the charging station, with the plug in a stowed position.

FIG. 7B shows the cable end plug and hanger clip portion from FIG. 7A, from a different perspective.

FIG. 7C is a perspective view showing an alternative example embodiment of a hanger clip.

FIG. 7D shows the cable end plug and hanger clip portion from FIG. 7C, from a different perspective.

FIG. 8 illustrates an embodiment of an example charging station.

FIG. 9 is a section view of an arm portion of the charging station shown in FIG. 8.

FIG. 10A is a side view of the charging station shown in FIG. 8, in a cable breakaway state.

FIG. 10B is a side view of the charging station shown in FIG. 8, in an overloaded state.

FIG. 10C is an enlarged detail section view taken from FIG. 9 showing example force limiting means for a pivot joint.

FIG. 10D is a perspective exploded detail of the components in FIG. 10C.

FIG. 11 is an enlarged detail section view similar to FIG. 10C, but showing an alternative embodiment of the force limiting means.

FIG. 11A is a perspective exploded detail of the components in FIG. 11.

FIG. 12 is a perspective view of an example charging station constructed in accordance with another embodiment of the invention, shown in a stowed position.

FIG. 12A is a perspective view of the charging station shown in FIG. 12, in a deployed position.

FIG. 13 is an exploded view of the charging station shown in FIG. 12.

FIG. 13A is an exploded view of the Electric Vehicle Supply Equipment (EVSE) portion of the charging station shown in FIG. 13.

FIG. 13B is an enlarged detail view taken from FIG. 13A.

FIG. 13C is an exploded view of the pivotjoint portion of the charging station shown in FIG. 13.

FIG. 14 is a side view the charging station shown in FIG. 12.

FIG. 15 is a cross section view through the arm portion of the charging station shown in FIG. 14.

FIG. 16 is a section view looking down of the arm portion of the charging station shown in FIG. 14.

FIG. 16A is an enlarged detail view taken from FIG. 16.

FIG. 17 is a section view taken from FIG. 16.

FIG. 17A is an enlarged detail view of the pivotjoint portion of the charging station, taken from FIG. 17.

FIG. 17B is an enlarged detail view of the distal portion of the charging station, taken from FIG. 17.

FIG. 18 is a cross section view of the distal end portion of the charging station, taken from FIG. 17B.

FIG. 19 is a cross section view of the distal end portion of the charging station, taken from FIG. 17B.

FIG. 20 is an exploded view of the breakaway fitting portion of the charging station.

FIG. 21 is a top view of a cable retainer portion of the breakaway fitting.

FIG. 22 is a perspective view of an example charging station constructed in accordance with another embodiment of the invention, shown in a stowed position.

FIG. 22A is a perspective view of the charging station shown in FIG. 22, in a deployed position.

FIG. 22B is a view looking up on the underside of the charging station shown in FIG. 22A.

FIG. 23 is an exploded view of the wall end pivotjoint portion of the charging station shown in FIG. 22.

FIG. 24 is a top view on the pivot joint shown in FIG. 23.

FIG. 25 is a section view of a portion of the pivot joint, taken from FIG. 24 with the joint in a normal use (underloaded) state.

FIG. 25A is a section view of a portion of the pivot joint, taken from FIG. 24, with the joint in an overloaded state.

FIG. 26 is a perspective view on the shear fitting.

FIG. 27 is an exploded view of the elbow joint portion of the charging station shown in FIG. 22.

FIG. 27A is a section view of the elbow joint portion of the charging station shown in FIG. 22.

FIG. 28 is a perspective view of a charging station similar to that shown in FIG. 22, but assembled in a different configuration.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive sense.

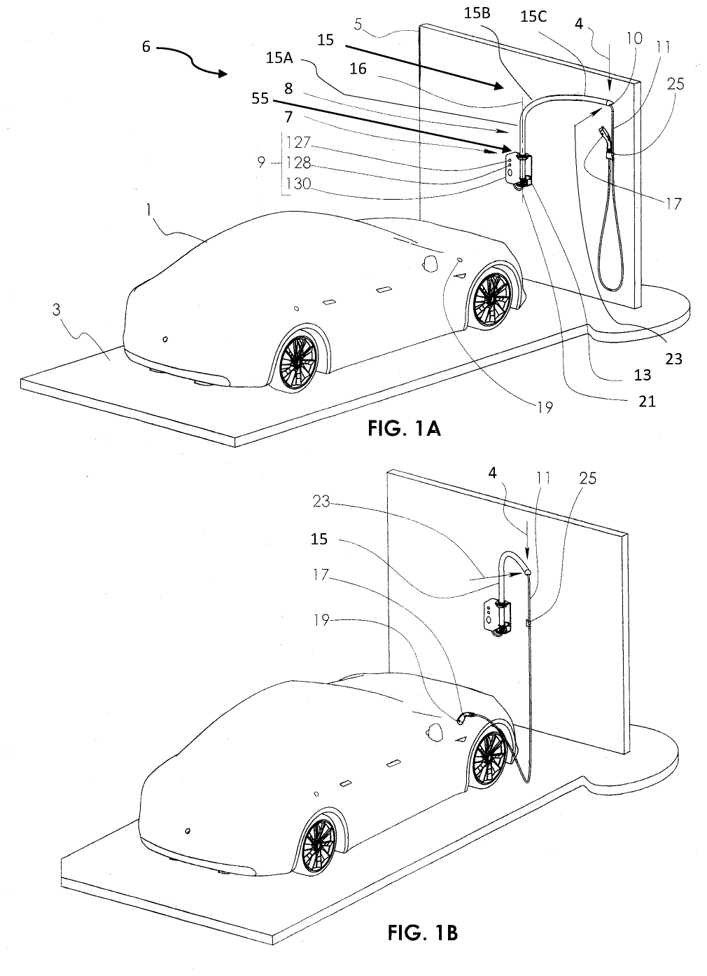

FIG. 1A illustrates an example EV charging station 6, in a stowed position. Electric vehicle 1 is shown parked on ground 3 at a distance from structure 5. Charging station 6 may be configured to accommodate EV 1 as long as EV 1 is within a selected distance range from structure 5. For example, charging station 6 may be designed to accommodate vehicle 1 if the distance from the front of EV 1 to structure 5 is in the range of 18 to 30 inches. Charging station 6 includes fixed portion 7, movable portion 8, and flexible charging cable 11. Pivot joint 55 pivotally connects fixed portion 7 to movable portion 8. Fixed portion 7 is attached to structure 5 and includes electric vehicle supply equipment (EVSE) 9 and mounting bracket 13. EVSE 9 is electrically connected to an electric power source (not shown) and to charging cable 11. EVSE 9 regulates electric power supply to charging cable 11. EVSE 9 optionally includes a sensor 127 and light 128. Optional sensor 127 has motion sensing means (for example, sensor 127 may be a digital camera and a processor configured to detect motion by processing image data acquired by the digital camera, a passive infrared sensor, an ultrasonic sensor, a microwave sensor, or a combination of these sensors). Sensor 127 is operative to monitor the area around the EVSE. In some embodiments EVSE 9 may be optionally configured to control light 128 in response to motion sensed by sensor 127. In some embodiments EVSE 9 may also optionally control light 128 to indicate the status of EVSE 9. EVSE 9 optionally includes wireless transceiver 130 providing two-way communication between EVSE 9 and, for example, an electric power provider and a cellphone network. The two-way communication may be applied for example for remotely monitoring the area around EVSE 9, and controlling functions of EVSE 9 remotely, and communicating the status of EVSE 9 to remote systems.

Movable portion 8 includes arm 15 and distal end fitting 10. Cable 11 is fixed to distal end fitting 10. Arm 15 includes a straight cylindrical proximal end portion 15A having axis 16, and a distal end portion 15C connected to proximal end portion 15A by a bent section 15B so that distal end portion 15C extends away from mounting bracket 13. Arm 15 may be made of 304 stainless steel tubing of about 2.25 inch outside diameter and about 0.188 inch wall thickness.

Plug 17 terminates charging cable 11, and establishes electrical connections to vehicle 1 when inserted into receptacle 19 of vehicle 1 (see FIG. 1B). Mounting bracket 13 defines pivot axis 21. Arm 15 is connected to mounting bracket 13 via pivot joint 55 such that arm 15 pivots about pivot axis 21. Pivot joint 55 may include a bias mechanism, for example a spring arrangement (shown in detail in subsequent Figures), such that a bias torque acts about axis 21 to move arm 15 in the direction indicated by arrow 23 in the absence of other forces. In the position shown, arm axis 16 and pivot axis 21 are coincident.

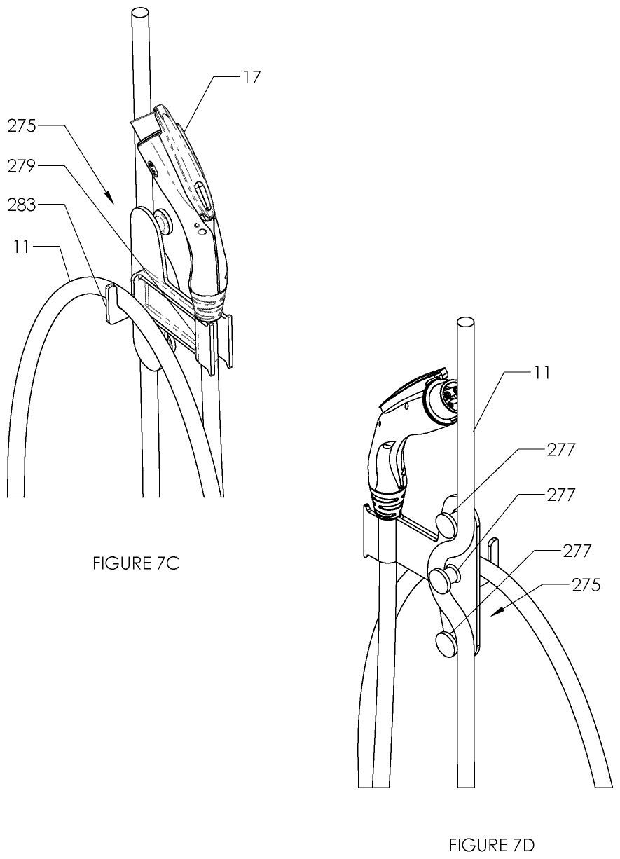

Clip 25 is attached to cable 11 at a suitable height from the ground 3. The position of clip 25 along cable 11 may be adjustable. For example, clip 25 may be held in place along cable 11 by a friction fit, an adjustable clamp or the like. In a stowed position, plug 17 may hang from clip 25. The length of cable 11 and reach of arm 15 are selected to provide the desired range of possible locations of plug 17 from fixed portion 7. Typically the length of cable 11 extending from end fitting 10 is selected such that cable 11 does not rest on the ground surface 3 when stowed in clip 25, however a longer cable 11 may be used. Clip 25 may additionally support one or more loops (see FIG. 7C) of cable 11. Depending on the height of clip 25 from ground surface 3 selected by the user and the selected length of cable 11 extending from end fitting 10, one or more loops of cable 11 may be hung on clip 25 such that cable 11 does not touch ground surface 3.

FIG. 1B shows the charging station from FIG. 1A in a deployed position, in which plug 17 is removed from clip 25 and inserted in receptacle 19 of an EV. A component of tension force in cable 11 (due to the weight of cable 11 in this position when plug 17 has been moved towards receptacle 19) acts against the bias torque pushing arm 15 in direction 23 to hold arm 15 in a deployed position different from the stowed position shown in FIG. 1A. A force applied to cable 11 or arm 15 may have a component in the direction of arrow 4.

FIG. 1C is a plan view looking down on the charging station as shown in FIG. 1B, showing arm midplane 51, deployed position angle 2. Other items shown are as described in the FIGS. 1A and 1B. Range of angle 2 may be zero to 180 degrees, where zero degrees represents the stowed position shown in FIG. 1A.

In the embodiment of FIGS. 1A to 1C, a proximal end portion 15A of arm 15 is cylindrical having axis 16, and is received vertically in mounting bracket 13. Midplane 51 of arm 15 is defined by axis 16 and the point along the centerline of cable 11 where cable 11 emerges from end fitting 10.

In some embodiments, pivot joint 55 includes a mechanical fuse which releases in the event that a force on the mechanical fuse exceeds a threshold. The mechanical fuse may be included in a mechanism that supports arm 15 and configured to release if more than a threshold amount of force, such as an abuse load in the direction of arrow 4, is applied at a distal end of arm 15. The mechanical fuse may, for example, comprise a member that is deformed (resiliently or inelastically) or breaks in response to application of a force on the member that exceeds a threshold.

Release of the mechanical fuse may result in pivot axis 16 of arm 15 shifting. For example, the mechanical fuse may hold a bearing or other component that defines the pivot axis in place until the mechanical fuse is deformed or broken as a result of a force on the bearing or other component in a direction transverse to the pivot axis. The mechanical fuse may be constructed in such a manner that a component must be replaced or a reset procedure must be performed to restore the pivot axis to its original orientation.

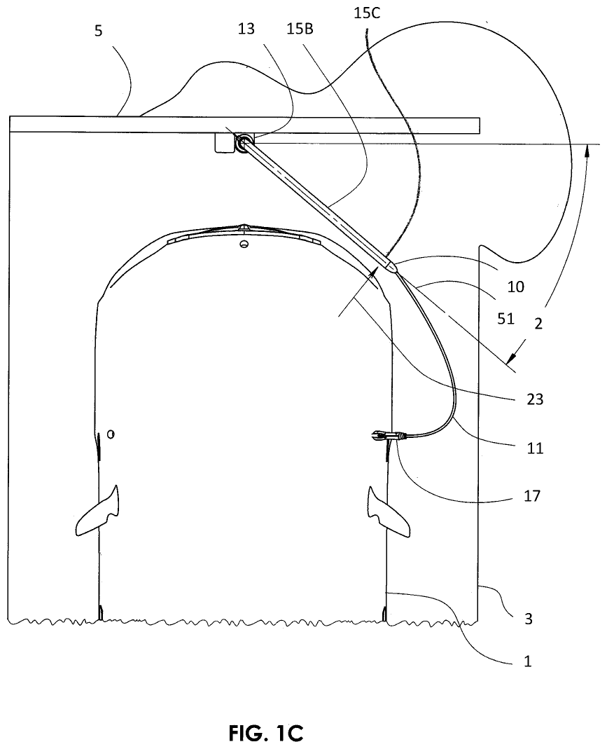

FIG. 2 is an exploded view showing components of an example pivot joint 55 that may be applied for connecting arm 15 to mounting bracket 13. Pivot joint 55 supports the proximal end portion 15A of arm 15 at spherical bearing 49. Bearing 31 is normally positioned so that axis 16 of proximal end portion 15A of arm 15 and axis 21 are both oriented vertically. Bearing 31 is mounted in a way that allows it to be slidably displaced in a direction toward the distal end portion 15C (see FIG. 1A) of arm 15. However, circlip 35 holds bearing 31 in place unless a moment applied to arm 15 is sufficient to pull bearing 31 out of gripping engagement by circlip 35, thus in pivot joint 55 circlip 35 serves as a mechanical fuse.

In alternative embodiments, alternative mechanical fuses such as shear pins, shear circlips, serrated plates, plastic inserts having shear webs, and fasteners with a preselected tension failure load range are provided to keep bearing 31 in place until an overload force is applied to arm 15.

Hole 18 passes through both walls of arm 15. The axis of hole 18 lies in midplane 51 of arm 15 (see FIG. 1C). Mounting bracket 13 has top bore 12 and lower bore 14, both cylindrical. Pivot axis 21 is coaxial with bores 12 and 14.

Inner bearing 31 has flange portion 36, cylindrical boss 38, and through inner bore 34. Bore 34 is a sliding fit over the outside diameter of proximal end portion 15A of arm 15. Outer bearing 29 includes flange portion 28, slot 33 through flange 28, hollow cylindrical boss 30, slotted holes 32 through both walls of boss 30, and threaded hole 52. The outer diameter of boss 30 is a sliding fit in bore 12. Slot 33 has a width selected to be a sliding fit with the outer diameter of boss 38 and a length greater than the width, allowing inner bearing 31 to slide in slot 33 for a selected distance in a direction normal to axis 16, for example, about % inch. The centrelines of slotted hole 32 and threaded hole 52 lie in the midplane of the width of slot 33.

Circlip 35 has screw hole 50, bore 24 and slot 26. Circlip 35 may be made of spring steel. Limit switch 53 is mounted to circlip 35. The outer diameter of boss 38 is a sliding fit in bore 24. The width of slot 26 is less than the outside diameter of boss 38. Axis 22 is perpendicular to axis 16, intersects the axis of hole 50, and lies in the midplane of the width of slot 26 and the plane of the bottom surface of circlip 35.

The width of slot 26 is selected along with the thickness, material properties, and outside profile of circlip 35 such that inner bearing 31 is slidable through slot 26 along the direction of axis 22 when a force above a predetermined threshold is applied to inner bearing 31 along the direction of axis 22. The resulting strain in the material of circlip 35 is selected to be within the elastic range of the material of circlip 35. When assembled, cross pin 39 passes through slotted holes 32 and hole 18 and is retained by cotter pin 41. Screw 37 fixes circlip 35 to outer bearing 29 via holes 50 and 52, thus outer bearing 29, circlip 35, screw 37, cross pin 39, and cotter pin 41 form an assembly that rotates together with arm 15 about axis 21. Axis 22 and the midplane of the width of slot 33 always remain coincident with midplane 51 of arm 15 (see FIG. 1C). Inner bearing 31 is free to slide along arm 15. Arm 15 and inner bearing 31 together may slide along slot 33 if sufficient force is applied to arm 15 in the direction of axis 22 as described above.

Base end fitting 47 has upper cylindrical boss 40, flange portion 42, lower cylindrical boss 44, and notch 46. Boss 40 is press-fit into the inner diameter of arm 15, such that the maximum amount of torque from torsion spring 27 can be transmitted via fitting 47 to arm 15. Boss 44 is a sliding fit into the inner bore of spherical bearing 49. Base end fitting 47 also has a through bore along axis 16 having a diameter greater than that of cable 11, so that cable 11 may pass through base end fitting 47. The outer diameter of spherical bearing 49 is a push-fit into bearing seat 45. Bearing seat 45 is a push-fit into bore 14 and has notch 48 that aligns with notch 20 when installed to allow an end of torsion spring 27 to pass through to engage in notch 20. Bearings 29 and 31 may be made from acetal. Bearing seat 45 and base end fitting 47 may be made from stainless steel.

When assembled, axis 16 is nominally coincident with axis 21, one end of torsion spring 27 engages notch 46, and the opposite end of torsion spring 27 passes through notch 48 to engage notch 20. Any torque generated in torsion spring 27 is therefore transmitted from mounting bracket 13 to arm 15. The relative angular position between notch 20 and notch 46 about axis 21 at a stowed position, along with the free (no torque) relative angular position between the ends of torsion spring 27 are selected to apply a selected preload torque biasing arm 15 towards the stowed position as shown in FIG. 1A, and the material and dimensions of torsion spring 27 are selected to provide the desired amount of torque biasing arm 15 towards the stowed position as arm 15 is deployed through the selected range of angle 2 (see FIG. 1C).

Referring also to FIGS. 1A, 1B, and 1C, pivot joint 55 described above for FIG. 2 limits the degrees of freedom in normal operation between the fixed portion 7 and moveable portion 8 of the charging station 6 to rotation about axis 16 and rotation about an axis 54 normal to midplane 51 of arm 15 and passing through the center of rotation of spherical bearing 49 (with the exception of a small amount of translation along axis 16, which is possible if arm 15 is lifted upwards, which is not considered normal operation).

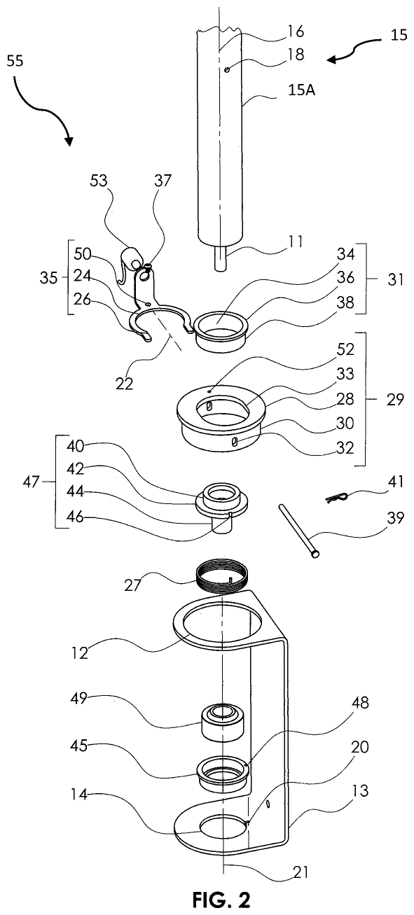

FIG. 3 is an enlarged view showing the fixed base unit portion of the charging station in more detail. EVSE 9 and mounting bracket 13 are attached to structure 5. Cable 11 exits proximal end portion 15A substantially concentric with axis 16 so that when arm 15 (see FIG. 1A) is pivoted about axis 16, cable 11 undergoes twist, but a minimal amount of flexion. Cable 11 is formed into a drip loop and is electrically connected to EVSE 9. Remaining items are as described in FIG. 2. Optional limit switch 53 signals a depressed or a released state to EVSE 9. Switch 53 is shown in contact with proximal end portion 15A in a depressed state.

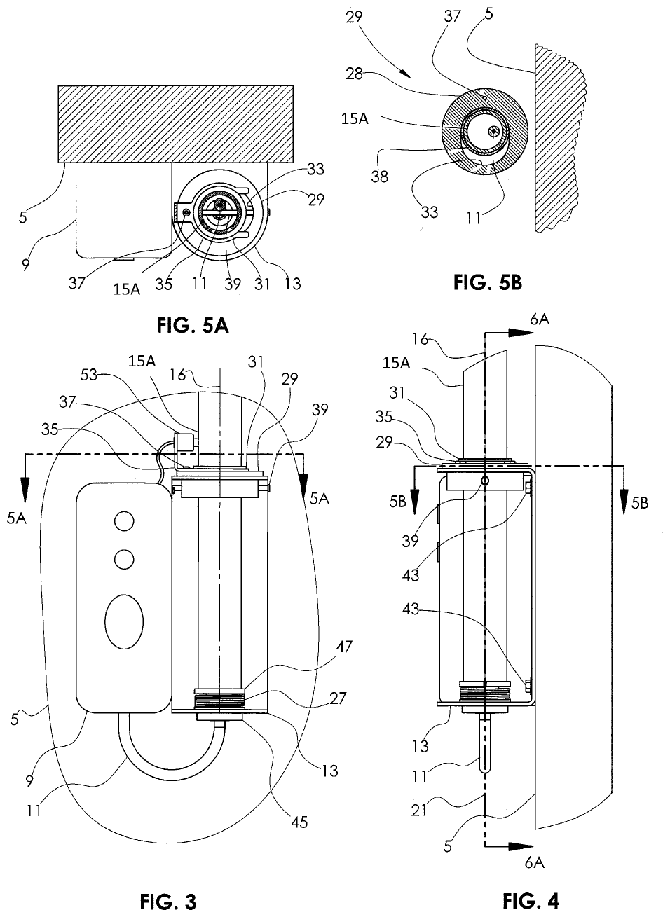

FIG. 4 is a side view on FIG. 3, showing attachment of mounting bracket 13 to structure 5 with fasteners 43. Cross pin 39 passes through proximal end portion 15A and outer bearing 29, thereby causing outer bearing 29 and attached circlip 35 to rotate about axis 21 along with arm 15 as arm 15 rotates about axis 16 (see FIGS. 1A and 1B). Also visible is inner bearing 31 and cable 11. Remaining items are as described in FIG. 2.

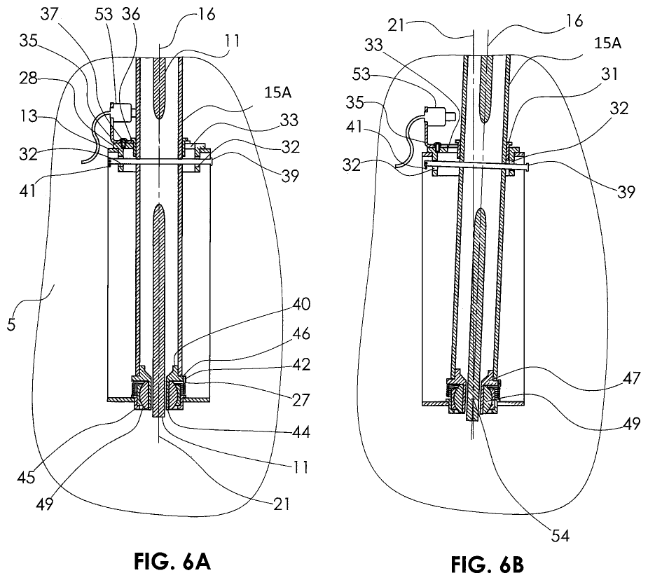

FIG. 5A is a section view taken from FIG. 3 in the plane 5A-5A, looking downwards. Cable 11 passes between cross pin 39 and the inner wall of proximal end portion 15A. Circlip 35 is attached to outer bearing 29 by screw 37. Inner bearing 31 and a portion of slot 33 are also visible.

FIG. 5B is a section taken from FIG. 4, in the plane 5B-5B through flange portion 28 of outer bearing 29, looking downward, with sections through structure 5, cable 11, proximal end portion 15A, screw 37 and boss 38 visible and showing the profile of slot 33.

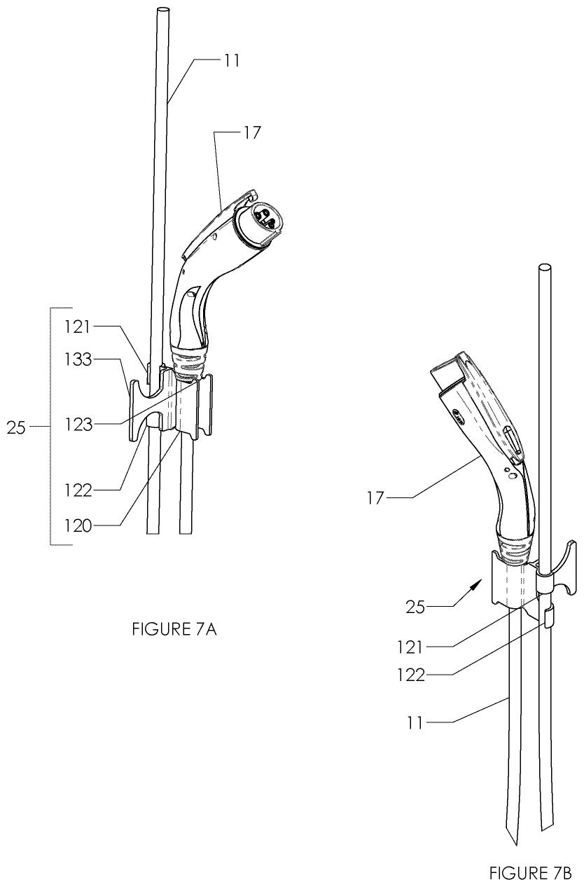

FIG. 6A is a section view taken from FIG. 4 in the plane 6A-6A, showing pivot joint 55 in normal operation mode in which axis 16 is coincident with axis 21. Other items shown are described in FIG. 2 and the description of operation section below.

FIG. 6B is a section view taken from FIG. 4 in the plane 6A-6A, identical to FIG. 6A except showing the pivot joint in an overload state in which axis 16 has moved to an overloaded position at an angle relative to axis 21, as described in FIG. 2 and the description of operation section below.

FIG. 7A is an enlarged perspective view showing plug 17 and clip 25. Clip 25 may be made, for example, of high-impact plastic. Flexible portions 121 and 122 are a friction fit on cable 11 and can flex to accommodate a selected range of diameters of cable 11. Cradle portion 120 is a clearance fit to the largest cable 11 in the selected diameter range and has tabs 123 which prevent plug 17 from falling out of clip 25 unless the user lifts plug 17 slightly to remove it. Hook portion 133 extends outward to provide means to hang one or two loops of cable 11. Clip 25 is symmetrical about a midplane normal to the axis of cable 11 so that it may be installed on cable 11 in either orientation.

FIG. 7B is an enlarged perspective view showing the components of FIG. 7A from a different angle, for clarity.

FIG. 7C is a perspective view showing an alternate embodiment of the hanger clip portion of the invention shown in FIG. 7A and FIG. 7B, that can accommodate a wider range of diameters of cable 11. D-shaped clip 275 may, for example be made of high-impact plastic and includes cradle portion 279 and hook portion 283. Plug 17 hangs in cradle portion 279 and hook portion 283 holds an extra loop of cable 11, similarly to the embodiment shown in FIG. 7A.

FIG. 7D shows the alternative cable end plug and hanger clip portion from FIG. 7C, from a different perspective. Cable 11 is threaded through three instances of boss 277 arranged to deflect cable 11 into a curve generating enough friction to hold clip 275 in position.

### Operation—Embodiment Shown in FIGS. 1 Through 7D

Charging station 6 is mounted to a structure 5 at a selected location relative to a parking area for vehicle 1 to provide the desired range of locations that can be reached with plug 17. The user unhooks plug 17 from clip 25 and takes plug 17 to receptacle 19 of vehicle 1, which may be in a variety of locations relative to the fixed portion 7 of station 6 depending on the type of vehicle and orientation it is parked in, and distance it is parked from structure 5.

Movable portion 8 of station 6 operates in a ‘follow me’ manner, in that when cable 11 is moved from a free-hanging position to a position where the center of gravity of cable 11 is a distance from arm midplane 51, arm 15 overcomes bias torque due to torsion spring 27 and swings out to a deployed position at angle 2. Upon returning plug 17 to clip 25 and allowing cable 11 to hang free in plane 51, arm 15 returns to a stowed position as shown in FIG. 1A. Bias torque due to spring 27 may be selected to provide unassisted return to the stowed position, or may be less, requiring the user to assist the return to the stowed position.

The user may adjust the position of clip 25 on cable 11 to a comfortable distance from the ground surface 3 by sliding cable 11 through flexible portions 121 and 122 of clip 25. Typically, the length of the free hanging portion of cable 11 is selected such that cable 11 does not touch the ground when plug 17 is stowed in clip 25 as shown, however in some cases a longer cable 11 may be used or the user may wish to stow cable 11 further from the ground. In these cases, the user may hang a loop of cable 11 in hook portion 133 of clip 25. Similarly, in the alternative embodiment of FIGS. 7C and 7D the user may adjust the position of clip 275 by sliding cable 11 through the group of three bosses 277 and may hang a loop of cable 11 on hook portion 283.

When an abuse load is applied to arm 15 creating a moment in midplane 51 that exceeds a selected threshold (for example, a downward force on arm 15 in the direction of arrow 4 due to a user pulling excessively on cable 11, or hanging or stepping on arm 15) and acts in a direction such that inner bearing 31 is urged to move out of engagement with circlip 35, inner bearing 31 slips though circlip 35 against the resilient forces applied by circlip 35, inner bearing 31 slides upwards on arm 15, cross pin 39 slides in slotted holes 32 and arm 15 moves through an angular motion in midplane 51 until inner bearing 31 hits the end of slot 33 and arm 15 is in a overloaded position as shown in FIG. 6B.

This creates an immediate tactile, audible indication and a persisting visual indication that too much load has been applied to arm 15. The threshold may be selected to be less than the load at which structural failure of station 6 or the attachment of station 6 to structure 5 could occur.

In the overloaded position shown in FIG. 6B, limit switch 53 does not contact arm 15 thus limit switch 53 is in a released state. Limit switch 53 communicates with EVSE 9 which may interrupt power supply to cable 11 when limit switch 53 is in the released state.

Arm 15 remains in the overloaded position shown in FIG. 6B until the user resets arm 15 to the vertical position as shown in FIG. 6A. The overloaded position may be designed to be, for example, an angle of about 2 degrees between axis 16 and axis 21 (see FIG. 6B). For example, arm 15 may be constructed with a distance of 48 inches (about 122 cm) from axis 16 to end fitting 10, in which case in the overloaded state end fitting 10 moves downwards (towards ground surface 3) about 2 inches (5 cm).

Optional sensor 127 communicates with EVSE 9 and senses motion in the vicinity of EVSE 9, for example when vehicle 1 or a user moves into a certain range around EVSE 9, EVSE 9 may turn light 128 on. Sensor 127 may also be used as a security monitor, communicating to the user's cellphone or home computer network or an alarm monitoring service via optional wireless transceiver 130.

EVSE 9 may additionally control light 128 to indicate state and fault conditions, for example by illuminating steady green when current is flowing to vehicle 1, steady red when current is not flowing, and flashing red for a fault condition such as overload on arm 15 resulting in limit switch 53 being triggered. Motion sensing functions of sensor 127 may also be used to detect when a vehicle is parked in a suitable position relative to the charging station by sensing the position of a selected feature of the vehicle. EVSE 9 may be configured to operate light 128 in a distinctive manner (e.g. by flashing light 128 and/or setting light 128 to a particular colour such as green) to indicate a vehicle position within a selected range of suitable positions.

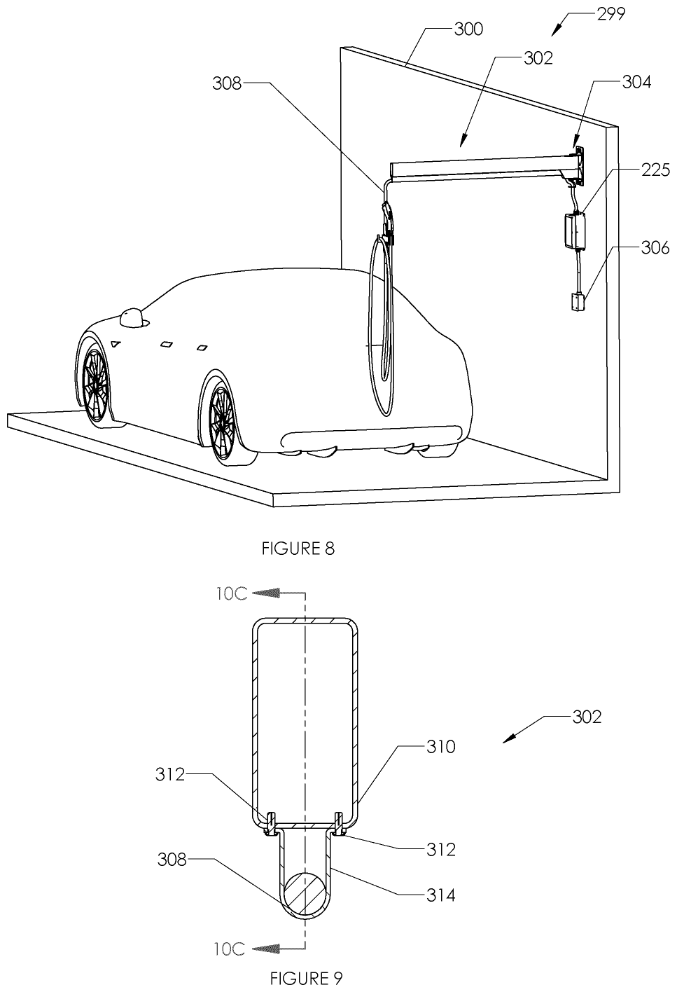

### Additional Embodiment—FIGS. 8-11

FIG. 8 illustrates another example charging station 299. In some embodiments a charging cable is coupled to a support arm by a breakaway mechanism. The breakaway mechanism may be configured to release the charging cable if a force on the charging cable in a selected direction relative to the support arm exceeds a threshold.

In some embodiments the cable is received in a downward facing groove or recess that extends longitudinally along the arm and the breakaway mechanism comprises one or more retaining members that hold the charging cable in the groove or recess. In some embodiments the breakaway mechanism comprises one or more retaining members (such as a channel member, straps, or the like) that hold the charging cable against an outer face of the arm. The retaining members may be affixed to the arm by attachments that release and/or the retaining members may themselves break or separate to allow the charging cable can come away from the arm if an applied force exceeds a threshold. Any embodiments of the present technology, including embodiments as illustrated in FIGS. 1 through 7D, may include a breakaway mechanism according to any of the examples described herein.

Pivot joint 304 and EVSE 225 are attached to structure 300. Arm 302 is pivotally attached to pivotjoint 304. Charging cable 308 is connected to EVSE 225 and is supported by arm 302 along substantially all the length of arm 302. EVSE 225 is connected to power source 306.

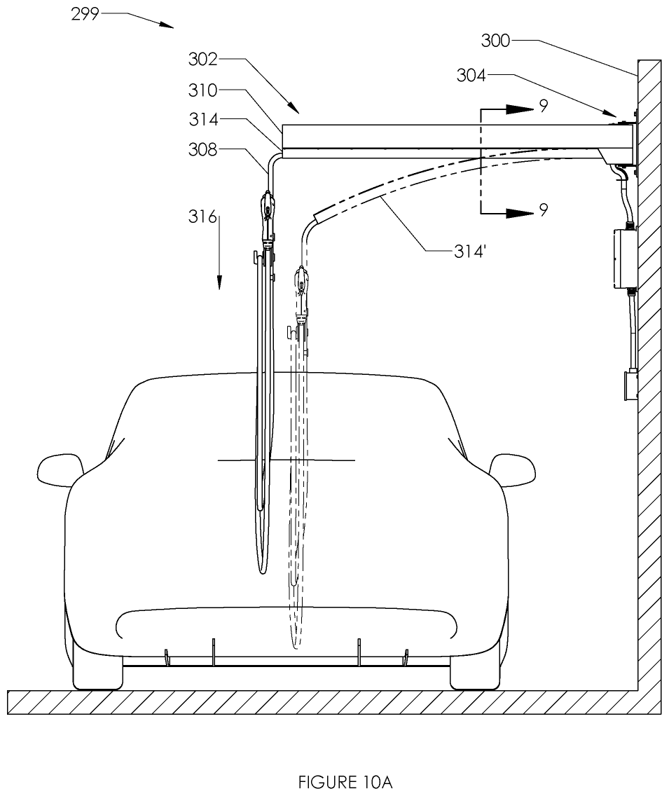

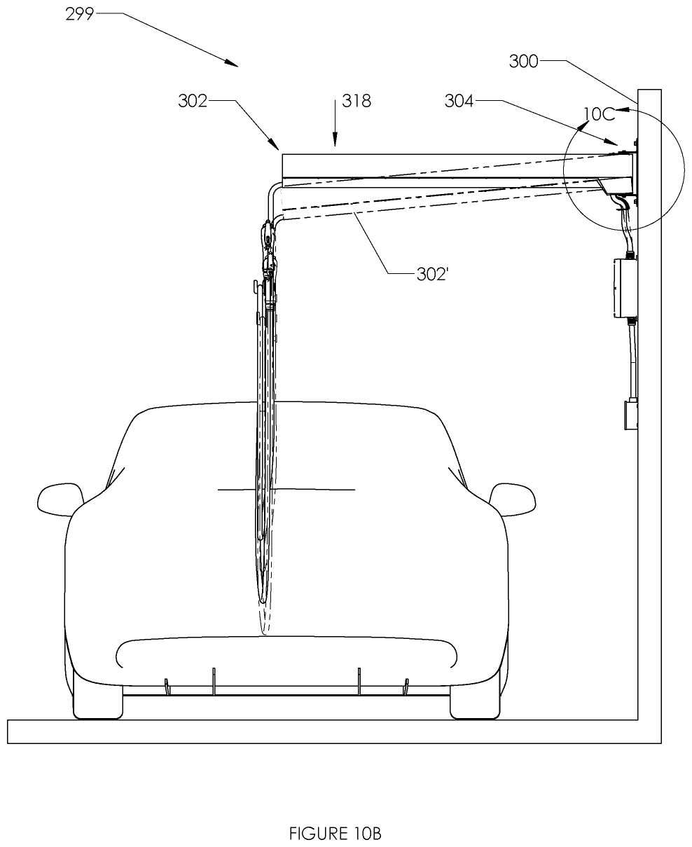

FIG. 9 is a cross section view of arm 302 taken from FIG. 10A along plane 9-9. Arm 302 includes rectangular tube 310. Breakaway conduit 314 is made of extruded plastic and is attached to tube 310 by plastic push-in rivets 312 spaced along the length of conduit 314. Charge cable 308 is supported by conduit 314.

FIG. 10A is a side view of charging station 299, in a cable breakaway state. Referring also to FIG. 9, when the component of load applied to cable 308 in the direction 316 reaches a predetermined range, rivets 312 pull elastically out of tube 310 thus breakaway conduit 314, along with cable 308, pull progressively away from tube 310 to breakaway state 314′. The strength, number and spacing of rivets 312 is selected to give the desired range of force on cable 308 required to cause conduit 314 to break away as shown (for example a force in the range of 40-60 pounds-force or about 18 to 28 kg force, or more acting downward). This desired range of force may be selected to be less than the force which would cause damage to arm 302, pivot joint 304, and/or the attachment of pivot joint 304 to structure 300.

FIG. 10B is a side view of charging station 299, in an overloaded state. When the bending moment in arm 302 generated by a load applied directly to arm 302 in the direction 318 reaches a predetermined range, force limiting means included in pivot joint 304 allow arm 302 to suddenly tilt downward to a overloaded position 302′. The bending moment range required to cause pivot joint 304 to move to the overloaded position 302′ may be selected to be greater than the bending moment generated by the cable breakaway force described in FIG. 10A, but less than the moment required to damage pivot joint 304 or the attachment of pivot joint 304 to structure 300.

FIG. 10C is an enlarged detail section view along the plane 10C-10C of FIG. 9 showing the force limiting means of pivot joint 304. Bearing 320 is a press fit in fusible link 67. Bearing 320 slides in slot 79 cut in tube 310. Shear pin 68 is a push fit in holes in fusible link 67 and tube 310 thus when shear pin 68 is intact, fusible link 67 is fixed relative to tube 310. Lower bearing 322 is press fit in arm 302. When bending moment within a predetermined range acts on arm 302 in direction 324, shear pin 68 shears and arm 302 rotates about bearing 322 until bearing 320 hits the end of slot 79. Slot 79 may be designed, for example, to allow bearing 320 to slide through a range of about 0.4 to about 0.75 inches (e.g. about 0.63 inches).

The material and diameter of shear pin 68 may be selected to provide the desired range of bending moment that will trigger the force limiting means. Different shear pins may be selected to provide a suitable range of moment 324 for various lengths of arm 302 and attachment arrangements of pivot joint 304 to structure 300.

One of ordinary skill in the art will recognize that various other means of elastic or inelastic force limitation may be applied as a mechanical fuse in place of fusible link 67 and shear pin 68, a few examples being sprung latches, circlips, or serrated plates held in engagement by spring force. The mechanical fuse may, for example be configured to be crushed, stretched, bent, broken apart, and/or released from holding another member or the like.

FIG. 10D is a perspective exploded view of the example force limiting means illustrated in FIG. 10C. Elements are as described with reference to FIG. 10C.

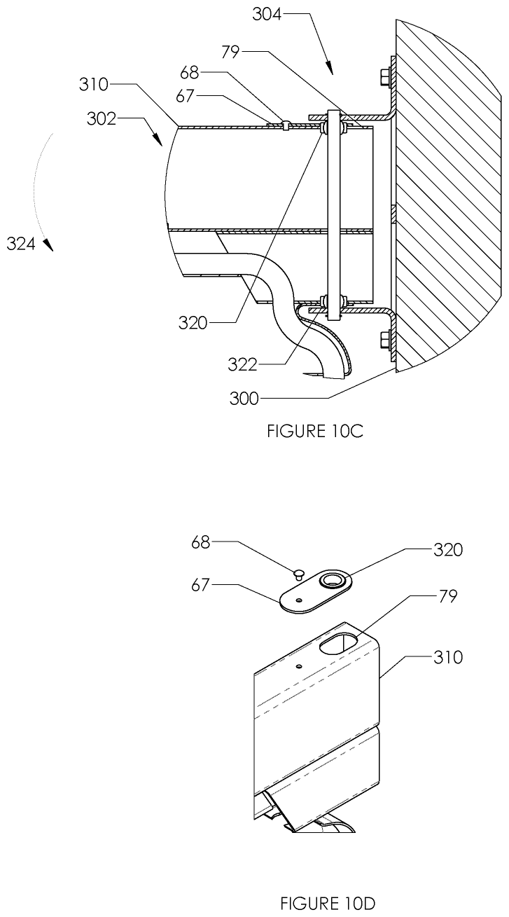

FIG. 11 is an enlarged detail section view similar to FIG. 10C, but showing an alternative embodiment of the force limiting means. Referring also to FIG. 10C, fusible link 67 is replaced with serrated plate 332, and shear pin 68 is replaced with shoulder bolt 330, spring washer stack 336, and serrated washer 334. Bearing 320 is press-fit into plate 332. Bearing 320 and plate 332 slide together relative to tube 310. Shoulder bolt 330 threads into tube 310, thereby compressing spring washer stack 336 to a predetermined preload, which in turn presses the serrations of plate 332 and washer 334 together.

Washer stack 336 may be made up of one or more steel Belleville washers. Different spring rates for stack 336 and different angles and engagement depth of the serrations of plate 332 and washer 334 may be selected to provide the desired range of moment 324 that allows arm 302 to move to overloaded state 302′ shown in FIG. 10B.

Compared to the embodiment shown in FIG. 10C, this embodiment of the force limiting means allows the normal use angle of arm 302 to be adjusted slightly at assembly, and the force limiting means is elastic rather than inelastic.

FIG. 11A is a perspective exploded view of the force limiting means illustrated in FIG. 11. Elements are as described with reference to FIG. 11.

### Operation—Embodiment Shown in FIGS. 8 Through 11

Arm 302 of charging station 299 pivots out from structure 300 when a user pulls cable 308 towards a vehicle. If the user applies an abuse load to cable 308 causing a downward pull reaching a predetermined range (for example if a child climbs or swings on cable 308), cable 308 pulls down progressively from arm 302 to a state 314′ thereby limiting the amount of abuse load that can be applied to cable 308 to a level which may be below selected load limits of the other components of charging station 299 and/or the attachment of station 299 to structure 300. In this particular example, the user must reinsert rivets 312 to restore cable 308 and conduit 314 from breakaway state 314′ to their normal use state.

In the case of an abuse load reaching a predetermined range being applied directly to arm 302 (for example, a person climbing or stepping directly on arm 302), shear pin 68 shears and pivot joint 304 moves abruptly to a tilted-down position such as overloaded state 302′ thereby warning the user that an excessive load has been applied. The predetermined range of load that moves arm 302 to overloaded state 302′ may be selected to be below a load that will detach joint 304 from structure 300. The user must replace shear pin 68 to reset pivot joint 304 and move arm 302 back from overloaded state 302′ to a normal use state. The change of position from a normal use state to state 302′ may be selected to be visually noticeable and sufficient to provide a tactile and audible feedback upon overload, while still maintaining a selected clearance to the ground (so that arm 302 does not contact a vehicle parked below).

In this particular example, arm 302 may be about 60 inches (about 2 m) long and may tilt toward the ground by about 5 degrees when moving from the normal use state to overloaded state 302′, resulting in the distal end (the end opposite joint 304) of arm 302 moving about 5 inches (about 12.5 cm) downward. The abuse load required to move arm 302 into overloaded state 302′ in this example may be about 150 pounds force (about 70 kg force) applied at the distal end of arm 302.

In the alternative embodiment shown in FIG. 11, moment 324 is transmitted to pivot joint 304 and structure 300 via shear between serrated plate 332 and serrated washer 334. When moment 324 reaches a predetermined range, serrated washer 334 moves upwards against the force of spring washer stack 336 until the serrations disengage, allowing arm 302 to tilt downwards to overloaded state 302′ as described for FIG. 10C. To reset pivot joint 304 and move arm 302 back from overloaded state 302′ to a normal use state the user must loosen shoulder bolt 330.

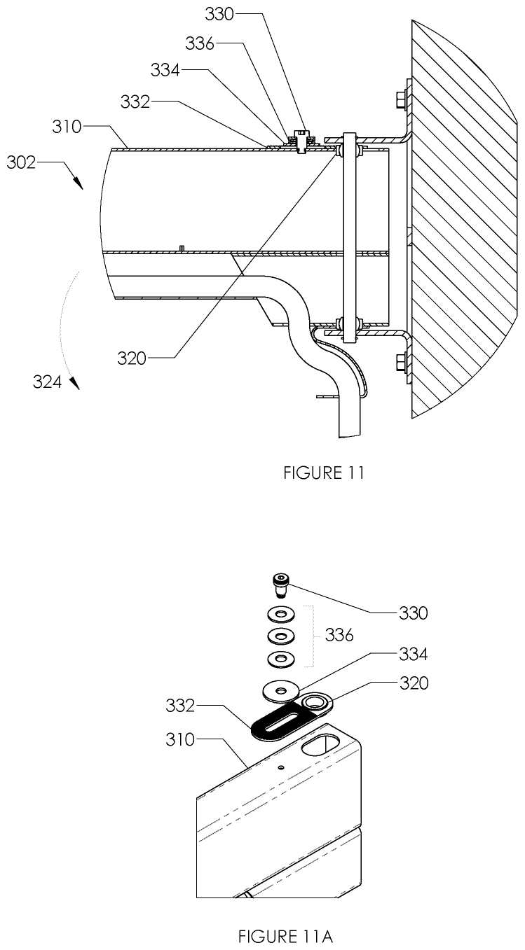

### Additional Embodiment—FIGS. 12-21

FIG. 12 is a perspective view of another example charging station 150 constructed in accordance with another embodiment of the invention, shown in a stowed position. Arm 151 is mounted via pivot joint 196 to ceiling mount 152 which is in turn mounted securely to ceiling structure 153. Power supply cable 154 runs from a power source through ceiling mount 152 and terminates at EVSE 170 which is attached to arm 151.

FIG. 12A is a perspective view of the charging station 150, but in a deployed position. Primary charge cable 156 is shown plugged in to vehicle 1, and secondary charge cable 157 is shown stowed.

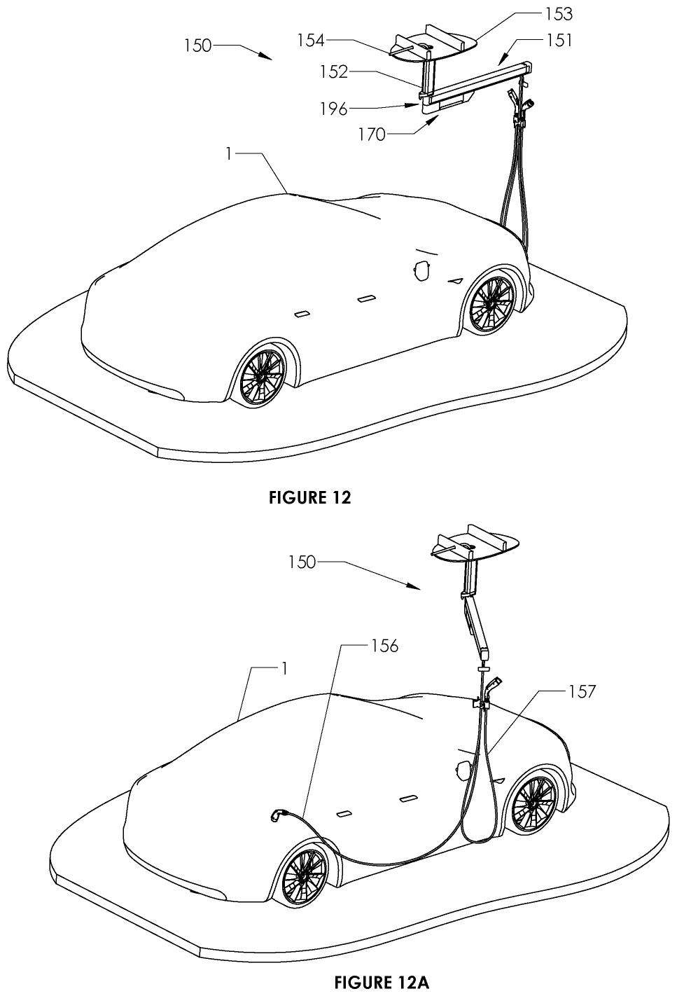

FIG. 13 is an exploded view of the charging station 150. Ceiling mount 152 includes spring ball plunger 163, circlip 164, bumper 165 and pivot tube 166. Arm 151 includes pivot fitting 158, extrusion 159, end cap 160, and optional indicator light and sensor unit 161. The sensor portion of unit 161 has motion sensing means (for example, sensor 127 may comprise a digital camera and a processor configured to detect motion by processing image data acquired by the digital camera, a passive infrared sensor, an ultrasonic sensor, a microwave sensor, or a combination of these sensors). The sensor portion of unit 161 may have image gathering means (for example unit 161 may include a digital camera).

Arm 151 rotates about the cylindrical axis of pivot tube 166. Power supply cable 154 passes through ceiling mount 152 and pivot tube portion 166 of ceiling mount 152 thus a portion of the longitudinal centreline of power supply cable 154 lies substantially on the axis of rotation of arm 151. Breakaway fitting assembly 210, optional illumination light unit 162, and optional EVSE 170 snap-fit into extrusion 159. Primary charge cable 156, optional 110V cable 129, and optional secondary charge cable 157 friction-fit into breakaway fitting 210. Optional low voltage cable 106 connects electrically to indicator light and sensor unit 161 and illumination light unit 162.

FIG. 13A is an exploded view of EVSE 170. EVSE 170 includes primary charge controller unit 172 and primary charge cable 156, and optionally includes wireless transceiver 130, secondary charge controller unit 173, secondary charge cable 157, 110V cable 129, and light and sensor control unit 174. Units 130, 172, 173, and 174 may be attached to enclosure 171 via typical electronic component to plastic housing methods. Primary charge cable 156 and 110V cable 129 are electrically connected to primary charge controller unit 172, optional secondary charge cable 157 is connected to secondary charge controller unit 173, and low voltage cable 106 is connected to light and sensor control unit 174.

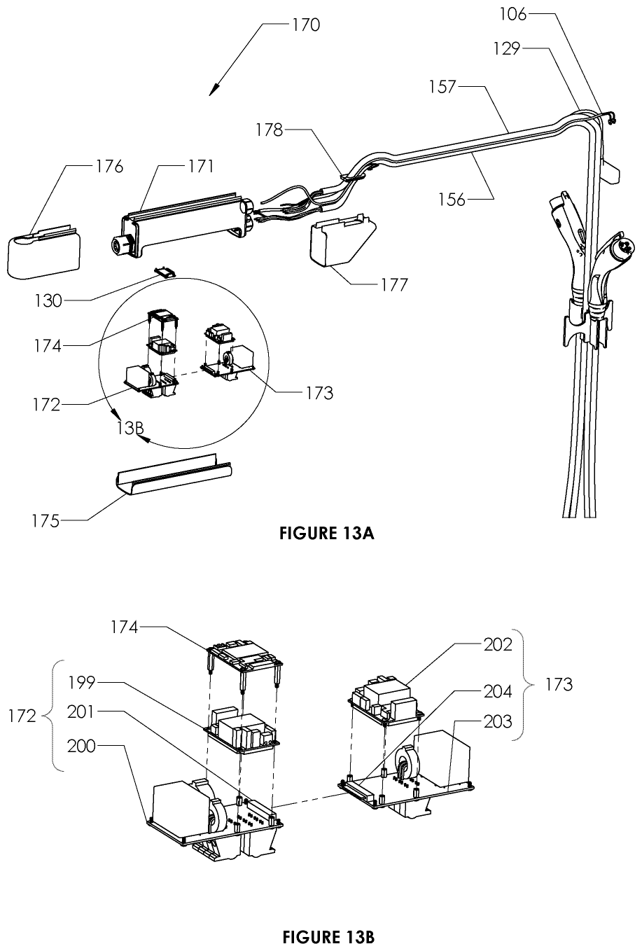

Access cover 175, supply cable shroud 176, and output cable shroud 177 may snap-fit to enclosure 171, and in turn shrouds 176 and 177 and enclosure 171 may snap-fit to extrusion 159 (see FIG. 15). Cables 106, 129, 156, and 157 pass through split grommet 178 and in turn grommet 178 fits to shroud 177, all with interference fits. Grommet 178 may, for example, be made of moulded flexible silicone.

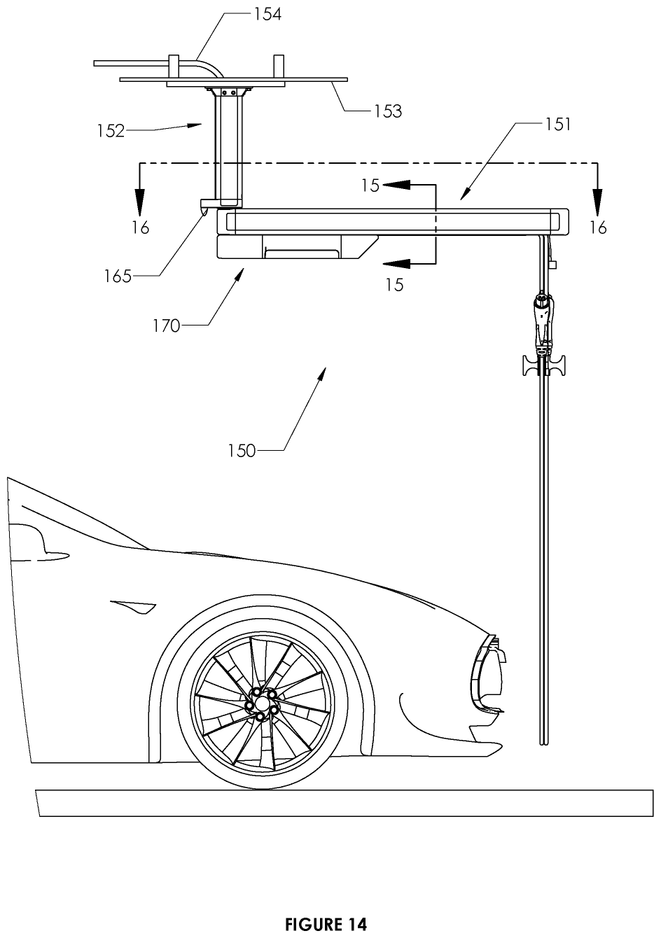

Cables 106, 129, 156, and 157 (and also power supply cable 154 seen in FIGS. 13 and 17) all enter and are attached to enclosure 171 via typical electrical cable gland bulkhead fittings.

FIG. 13B is an enlarged detail view taken from FIG. 13A. Primary charge controller unit 172 includes primary EVSE controller 199, primary power distribution board 200, and female board edge connector 201. Power distribution board 200 includes typical wire connection terminals suitable for a 4-wire 240 VAC supply power supply (including a neutral wire), power voltage step-down from 240 VAC input to 110 VAC output, and typical wire connection terminals suitable for a 3-wire 110 VAC output cable. Power distribution board 200 also includes other components typical to existing EVSEs including a relay, ground fault detection loops for both supply power and charge output power, and wire connection terminals for supply power, and charge output power.

Connections between controller 199 and board 200 are made as required for relay and ground fault detection operation with typical low voltage signal wiring and connectors (not shown). Optional secondary charge controller unit 173 includes secondary EVSE controller 202, secondary power distribution board 203, male board edge connector 204, and other components typical to existing single charge circuit EVSEs including a relay, a ground fault detection loop for charge output power, and wire connection terminals for charge output power. Power connection is made between primary charge controller unit 172 and secondary charge controller unit 173 via board edge connectors 201 and 204. In some embodiments secondary charge controller unit 173 is configured as a plug-in module such that EVSE 170 may be easily upgraded to provide a second charge controller for a second EV.

Referring also to FIG. 13A, low voltage signal connections between wireless transceiver 130, light and sensor control unit 174, controller 199, board 200, controller 202, and board 203 are made as required with typical signal wiring and connectors, and are not shown in detail. EVSE controllers 199 and 202 may be OpenEVSE v5.5 Universal EVSE controllers (OpenEVSE LLC, Monroe NC).

FIG. 13C is an exploded view of pivot joint 196 of charging station 150. Pivot fitting 158 is mechanically bonded and fastened to extrusion 159. Detent plate 167 has radial grooves 168 at selected angular positions defining a set of selected detent-controlled stowed positions of arm 151. Detent plate 167 is fixed to fitting 158 by friction-fit spring pins 169. Referring also to FIGS. 12, 16, and 17A, radial grooves 168 engage with spring ball plunger 163 at the selected stowed positions of arm 151. Detent plate 167 may be replaced or repositioned as required to provide different set of stowed positions of arm 151.

Upper bearing 187 may be push or press fit into fitting 158 and lower bearing 182 may be push or press fit into adjuster 179. Both bearings 182 and 187 may, for example, be trade number 6807 ball bearings. Adjuster 179 is a sliding fit in fitting 158. Adjustment screw 180 threads into adjuster 179, and is retained axially within fitting 158 by circlip 181. Referring also to FIG. 17A, adjuster 179 thus can move relative to fitting 158 only along the cylindrical axis of screw 180, when screw 180 is turned, and screw 180 is fixed to fitting 158 in all degrees of freedom except rotation about the cylindrical axis of screw 180.

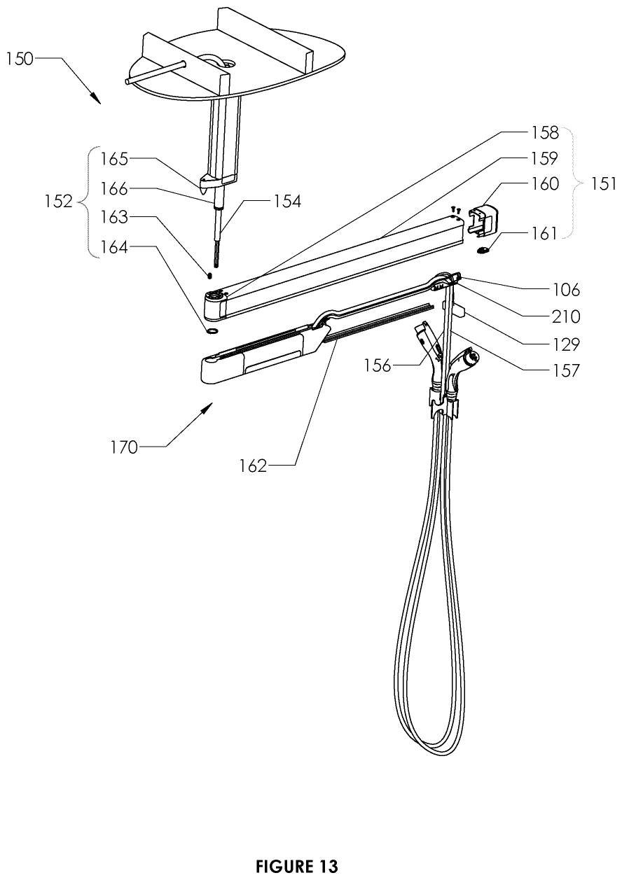

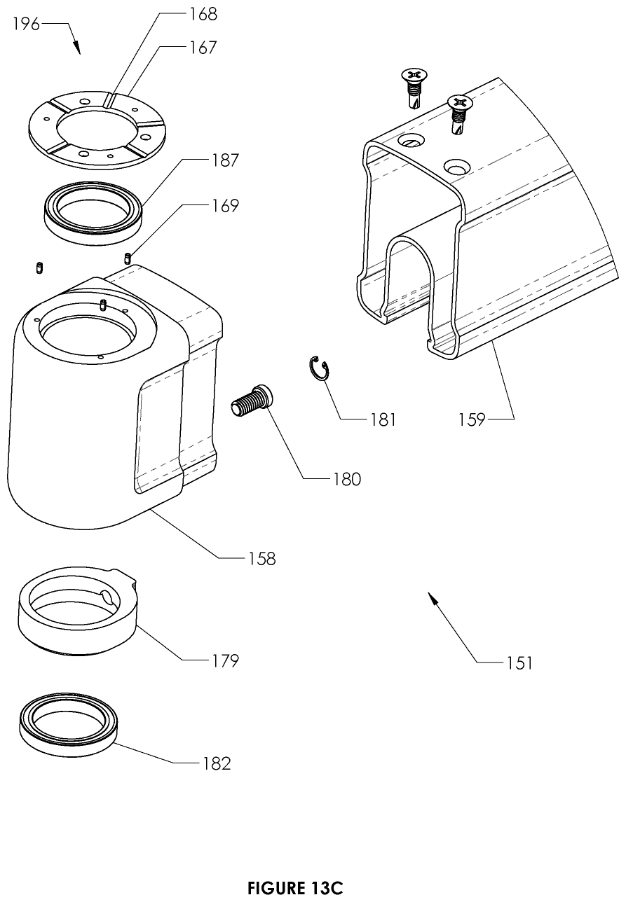

FIG. 14 is a side view of charging station 150. Ceiling mount 152 is attached to ceiling structure 153 using typical construction methods appropriate for the particular type of structure 153 (for example joists and drywall as shown, or concrete) and having sufficient strength to withstand selected abuse loads applied to arm 151 at any position of arm 151 within a range of motion shown in FIG. 16. Bumper 165 is fixed to mount 152 and limits the travel of arm 151 to less than 360 degrees. Power supply cable 154 and EVSE 170 are also shown.

FIG. 15 is a cross-section through arm 151 of the charging station 150 taken from FIG. 14 along plane 15-15. Extrusion 159 may be closed constant section bounded by a rectangle approximately 4 inches (10 cm) high by 2.75 inches (7 cm) wide, and has a concave channel region which may have approximate inside dimensions 1.1×2.1 inches (2.8×5.3 cm). Extrusion 159 may for example be made of 6063-T5 aluminum having wall thickness of approximately 0.10 inches (0.25 cm).

Illumination light unit 162 includes backing strip 188, LED light strip 189, and lens 190, and snaps into the groove features of extrusion 159, thus forming an enclosed conduit for 110V cable 129, primary charge cable 156, secondary charge cable 157, and low voltage cable 106 along the length of extrusion 159. Cover strip 185 (see FIG. 16A) may be optionally substituted for light unit 162.

FIG. 16 is a section view taken from FIG. 14 along plane 16-16. Arm 151 has midplane 155. Arm 151 pivots through the range between maximum angles 183 and 184. The sum of angles 183 and 184 is limited to a maximum of 360 degrees to limit the twist of cable 154 (see FIG. 17). Angles 183 and 184 may be equal, and there may be selected stowed positions at values of zero, 90, and 147.5 degrees for each of angles 183 and 184.

FIG. 16A is an enlarged detail view taken from FIG. 16, showing the cross section through ceiling mount 152. Extrusion 186 is cut to from the same material as extrusion 159 (see FIG. 15). Power supply cable 154 is enclosed by snap-in cover strip 185. A suitable material for cover strip 185 is extruded PVC. Spring ball plunger 163 can be adjusted by removing strip 185.

FIG. 17 is a section view taken from FIG. 16 along plane 17-17. Ceiling mount 152 is securely attached to structure 153. Ceiling mount 152 includes a selected length, for example about 2 feet (60 cm), of extrusion 186. Referring also to FIG. 16A, for situations where power supply cable 154 cannot be routed through structure 153 and instead is attached to the exposed surface of structure 153 (for example in the case of a concrete ceiling), cover strip 185 may be cut short and cable 154 may be routed into the conduit space enclosed by strip 185 and extrusion 186 at a selected position along extrusion 186. Cable 154 is shown connected to EVSE 170 which in turn is attached to arm 151.

FIG. 17A is an enlarged detail view of pivot joint 196 of charging station 150, taken from FIG. 17, showing arm 151 assembled to mount 152. Bearings 182 and 187 slide over pivot tube 166. Fixed pivot axis 194 lies along the cylindrical axis of pivot tube 166. Circlip 164 supports bearing 182. Referring also to FIG. 16, the angle 193 of arm 151 relative to pivot axis 194 in the vertical midplane 155 of arm 151 may be adjusted by turning screw 180. A bending moment in midplane 155 and in the direction of arrow 191 (for example caused by an abuse load acting on arm 151) is reacted by circlip 181. The strength of circlip 181 is selected such that circlip 181 shears within a predetermined range of bending moment in arm 151. When circlip 181 shears, adjuster 179 slides within fitting 158 in the direction of arrow 192 until gap 195 closes, creating an audible and tactile indication that excessive abuse load has been applied to arm 151, and an increase in angle 193. Play due to clearances in bearings 182 and 187 is sufficient to allow angle 193 to vary with a range defined by the limits of travel of adjuster 179 in fitting 158.

FIG. 17B is an enlarged detail view of the distal end portion of charging station 150, taken from FIG. 17. Breakaway fitting assembly 210 includes main body 211, end plug 212, and cable retainer 213. Main body 211 has flexible tab portion 215 and end plug 212 has flexible tab portion 216. Primary charge cable 156 and secondary charge cable 157 are a friction fit in cable retainer 213, and 110V cable 129 is friction fit in end plug 212. Low voltage cable 106 is shown connected to indicator light and sensor unit 161, which snap-fits into end cap 160. End cap 160 is mechanically fastened to extrusion 159. Fitting assembly 210 snap-fits into extrusion 159.

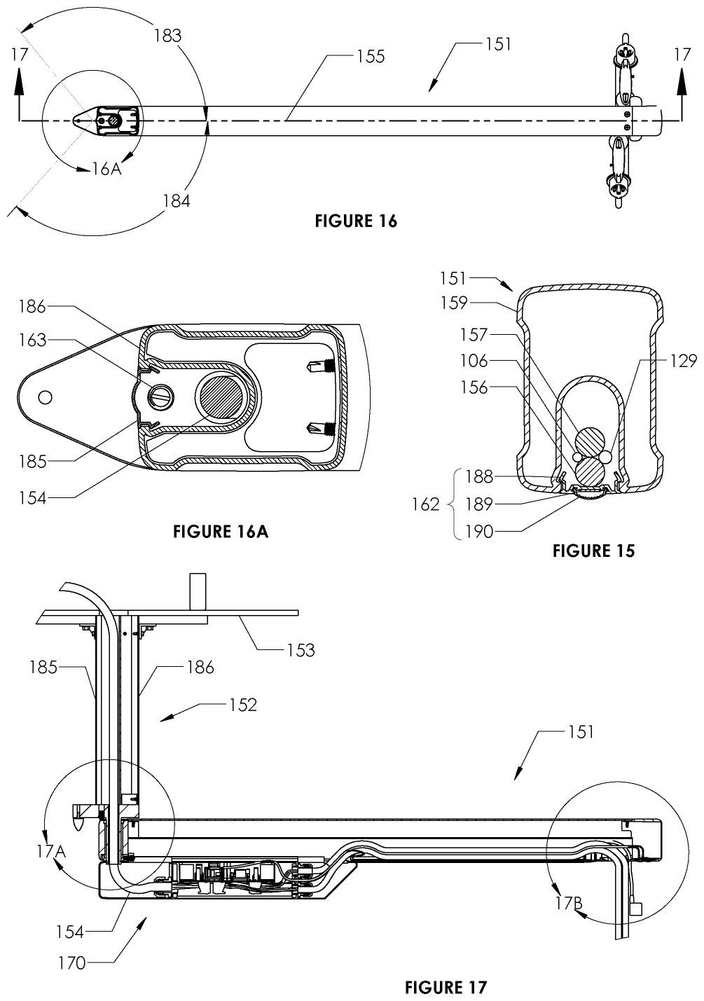

FIG. 18 is a cross section of the distal end portion of arm 151, taken from FIG. 17B along plane 18-18. Flexible tabs 215 of main body 211 engage grooves in the profile of extrusion 159 and flex inwards when a selected level of force in direction 217 is applied to main body 211 due to excessive downward load on cables 156 and/or 157.

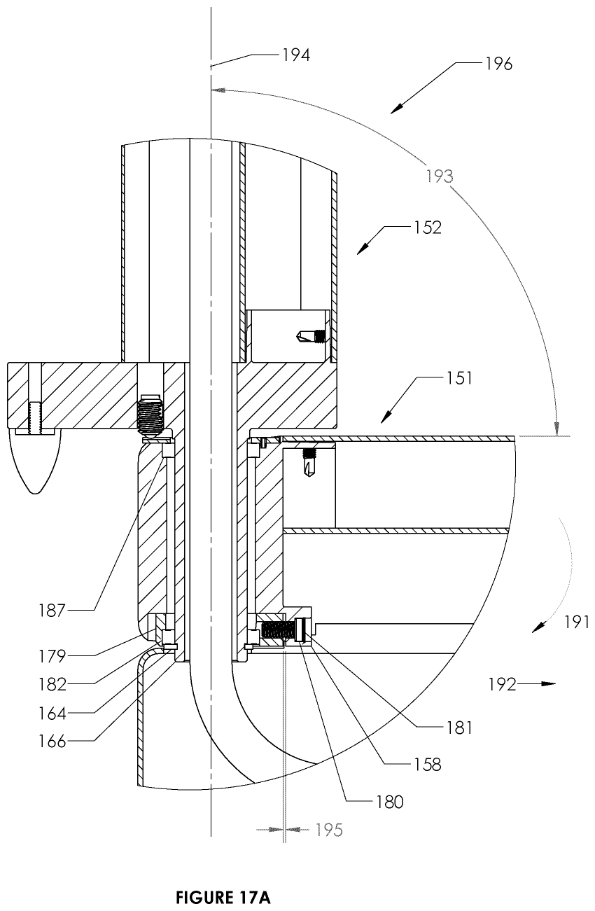

FIG. 19 is a cross section view of the distal end portion of arm 151, taken from FIG. 17B along plane 19-19. Flexible tabs 216 of end plug 212 engage grooves in the profile of extrusion 159 and flex inwards when a selected level of force in direction 217 is applied to end plug 212 due to excessive downward load on 110V cable 129.

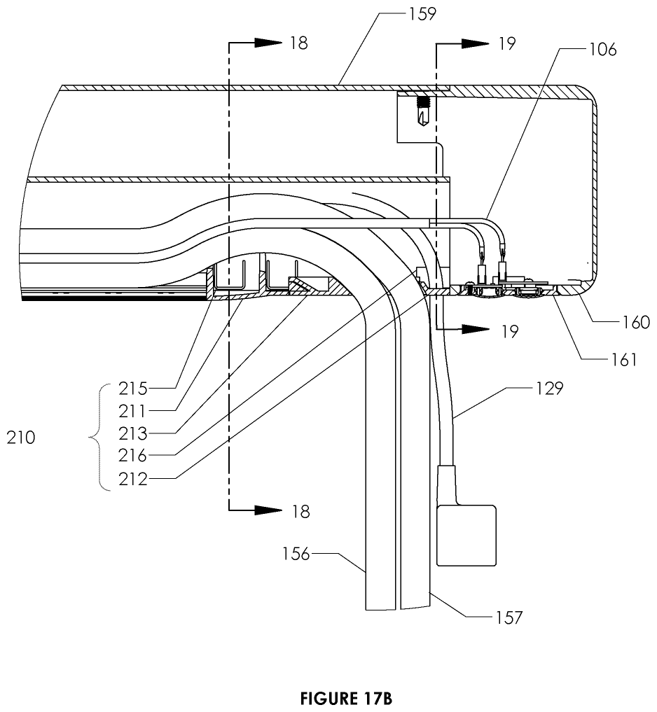

FIG. 20 is an exploded view of breakaway fitting assembly 210 showing flexible tabs 215 of main body 211 and tabs 216 of end plug 212. Cable retainer 213 holds two cables 156 and 157 of about 0.56 inch diameter. Cable retainer 213 mechanically interlocks with main body 211 and end plug 212 such that forces on cable retainer 213 are transmitted to main body 211 and end plug 212. Alternative cable retainer 214 also mechanically interlocks with main body 211 and end plug 212 and holds a single cable.

Retainer 214 has removable portion 218, which can be cut away to allow retainer 214 to hold a second cable. Retainers 213 and 214 form set 219. Additional retainers may be added to set 219 to fit various diameters of charge cables in single and dual cable configurations. Referring also to FIGS. 17B, 18 and 19, the material stiffness of main body 211 and end plug 212 and the thickness of flexible tab portions 215 and 216 are selected such that main body 211 and end plug 212 pull out of extrusion 159 at a selected range of total downwards pull applied to cables 156, 157, and/or 129. The parts comprising fitting assembly 211 and retainer set 219 may be made of injection moulded ABS plastic.

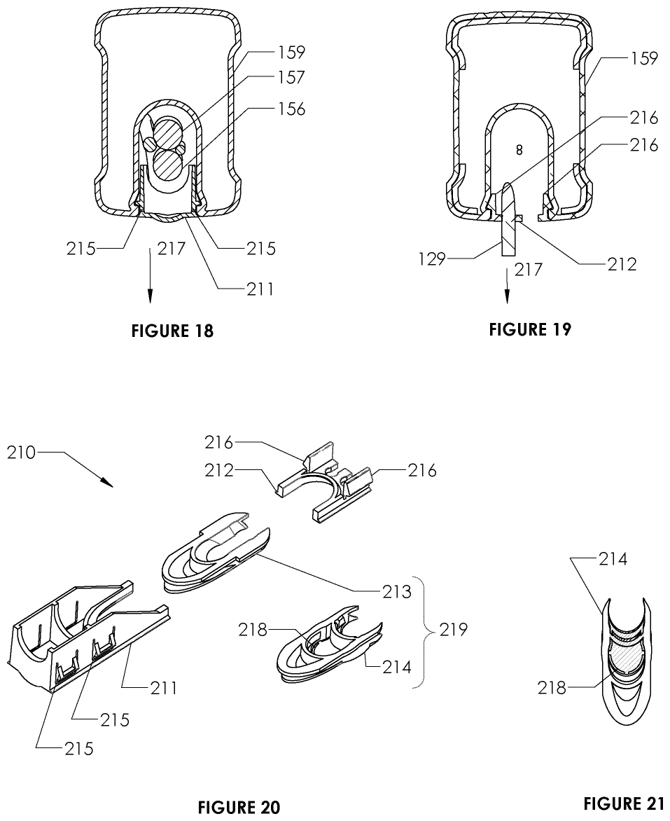

FIG. 21 is a top view of cable retainer 214, showing removable portion 218 indicated by the crosshatched region. To add a second charge cable, the user removes portion 218 by cutting along the slots and recesses around the perimeter of portion 218.

### Operation—Additional Embodiment Shown in FIGS. 12-21

In the position shown in FIGS. 12 and 16, arm 151 of charging station 150 is in a stowed position in-line with vehicle 1. The user pulls cable 156 or 157 toward the desired location on vehicle 1. Arm 151 follows by rotating as required through some portion of angle 183 or angle 184. At selected angles within the range of angles 183 and 184, plunger 163 engages a detent groove 168 and arm 151 stops at that position until pulled further by the user.

If an abuse load is applied as a downward pull on cables 156, 157, or 129 or any combination of these (for example a person hanging on or climbing the cables), breakaway fitting 210 pulls out of arm 151. If tension continues, the cables pull light unit 162 out of arm 151. The allowable downward pull on cables 156, 157, or 129 may be selected to be less than the threshold load required to shear circlip 181.

If an abuse load is applied directly to arm 151 creating a downwards bending moment 191 in arm 151 beyond a selected threshold (for example by a person applying weight directly to arm 151 rather than cables 156, 157, or 129), circlip 181 shears and arm 151 tilts noticeably downward as adjuster 179 hits the limit of travel in fitting 158. The selected shear load capacity of circlip 181 may be selected in relation to the selected length of arm 151.

EVSE 170 may be operated with primary charge controller unit 172 and charge cable 156 only, and with cable retainer 214 in breakaway fitting assembly 210, then expanded later to add an optional second charge output for a second vehicle by plugging secondary charge controller unit 173 into unit 172, adding cable 157, and cutting away section 218 of cable retainer 214 or selecting an alternative cable retainer from set 219 as required to fit the number and diameter of charging cables. Optional light and sensor control unit 174 and wireless transceiver 130 may be programmed to activate light unit 162 when motion is sensed by indicator light and sensor unit 161. The indicator light portion of unit 161 may be activated by signals from controllers 199 and 202 to indicate the status of EVSE 170.

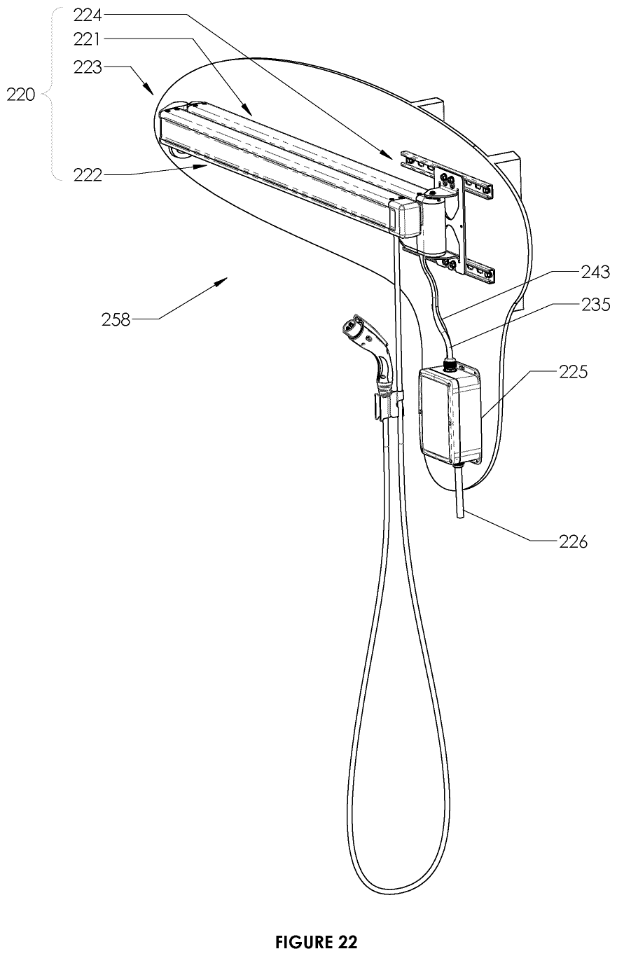

### Additional Embodiment—FIGS. 22 Through 28

FIG. 22 is a perspective view of another example charging station 258, shown in a stowed position. Articulated arm 220 includes proximal arm 221, distal arm 222, elbow joint 223, and wall pivot joint 224. Wall mounted EVSE 225 is connected to power supply 226, charging cable 235, and low voltage cable 243. Arm 220 supports cables 235 and 243. A free-hanging portion of cable 235 exits distal arm 222. A portion of cable 235 may be hung on clip 25.

FIG. 22A is a perspective view of charging station 258, but with articulated arm 220 in a deployed position. Wall pivot joint 224 is shown rotated 90 degrees from the stowed position shown in FIG. 22. Wall pivot joint 224 may have a range of, for example, 180 degrees. Proximal arm 221 and distal arm 222 are connected by elbow joint 223. Elbow joint 223 is shown opened to a maximum range of travel of less than 180 degrees from the stowed position, for example 175 degrees. Elbow joint 223 has a mechanical stop at the maximum range of travel.

FIG. 22B is a view looking up on the underside of charging station 258. Proximal arm 221 and distal arm 222 each include an indicator light and sensor unit 161. Charging cable 235 and low voltage cable 243 enter proximal arm 221 near wall pivot joint 224 through split grommet 236, exit proximal arm 221 at breakaway fitting 210 (described in FIGS. 17B through 21), loop underneath elbow joint 223, enter distal arm 222 at another instance of breakaway fitting 210 and finally exit distal arm 222 at a third instance of breakaway fitting 210. Charging cable 235 and low voltage cable 243 can thus be installed in arm 220 without needing to be disconnected from EVSE 225.

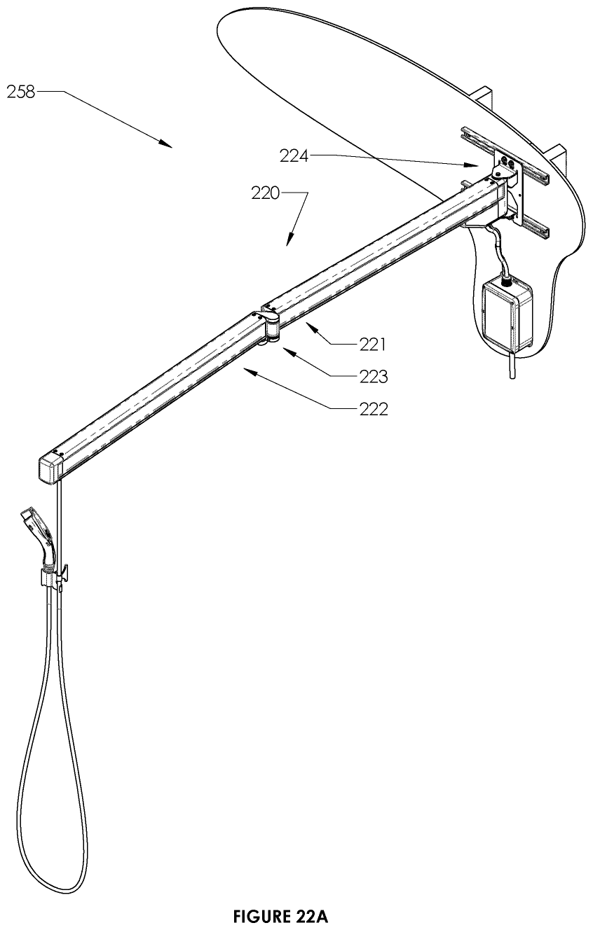

FIG. 23 is an exploded view of wall pivot joint 224. Proximal arm 221 includes a length of extrusion 159 (described in FIG. 15) mechanically bonded and fastened to wall pivot fitting 232. Pivot fitting 232 is pivotally attached to wall bracket 237 with D-section pivot pin 233, lower spherical bearing 238, and upper spherical bearing 231. Bearing 231 is a sliding fit in fitting 232 such that it can move relative to fitting 232 in the midplane of extrusion 159. Shear fitting 227 is a push fit into fitting 232, and holds bearing 231 in a normal use position where proximal arm 221 is horizontal. Indicator 228 is a friction fit into shear fitting 227 and a sliding fit in window slot 239 of fitting 232.

Torsion spring 229 has one end which engages spring seat 230 and another end which bears against fitting 232. Spring seat 230 is a push fit onto pin 233 and is rotationally locked to D-section pivot pin 233, which in turn is rotationally locked to wall bracket 237. Thus spring 229 applies torque to fitting 232 acting to keep arm 221 in the stowed position shown in FIG. 22.

Wall bracket 237 includes two instances each of keyhole shaped hole 256 and slotted hole 257, allowing a person working alone to install arm 220 by preinstalling at least two and up to four flanged bolts (not shown), hanging arm 220 (preassembled to wall bracket 237) on the bolts, lightly tightening the bolts, optionally adjusting arm 220 to be level horizontally, and then tightening all four bolts.

Wall bracket 237 includes a plurality of bend relief slots 264. The size of slots 264 may be selected, along with the thickness and material properties of bracket 237, such that bracket 237 permanently deforms at a predetermined range of load on wall pivot joint 224. For example, the range of load required to deform bracket 237 may be selected to be less that the range of load causing the bolted attachment of bracket 237 to a structure to fail.

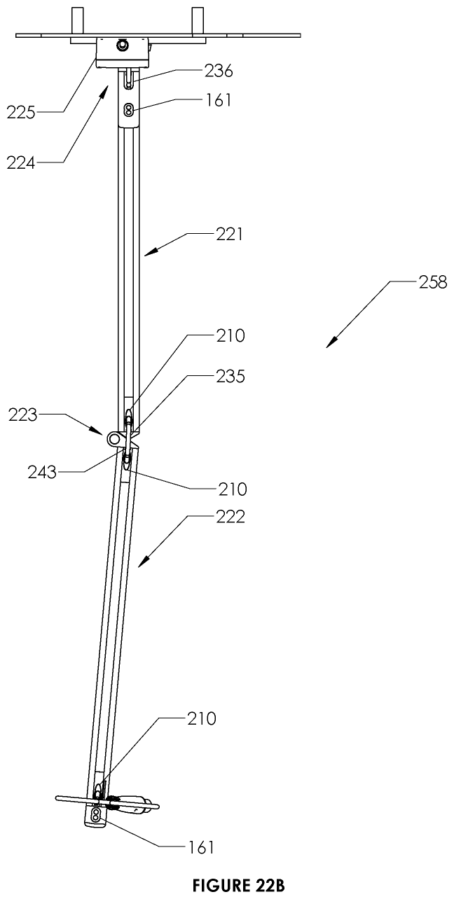

FIG. 24 is a top view on wall pivot joint 224 with a portion of wall bracket 237 broken out to show the arrangement of shear fitting 227 in a normal use state. In this state indicator 228 is hidden within fitting 232 and shear webs 234 are intact. The remaining items are as described in FIG. 23.

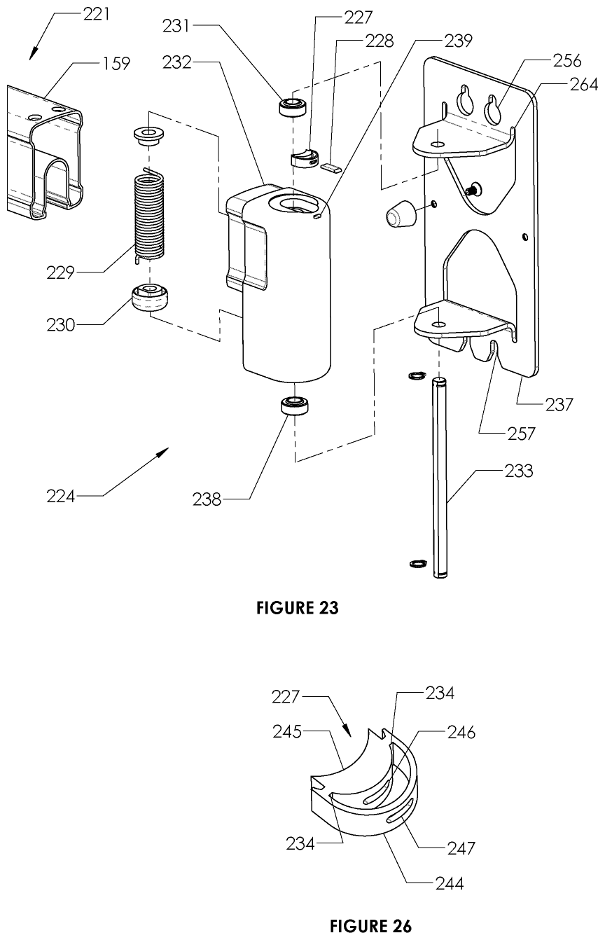

FIG. 25 is a section taken from FIG. 24 along plane 25-25, in a normal use state. Shear fitting 227 has gap 240 to fitting 232, pin 233 is fixed to bracket 237, arm 221 along with fitting 232 are nominally horizontal and indicator 228 is hidden within fitting 232.

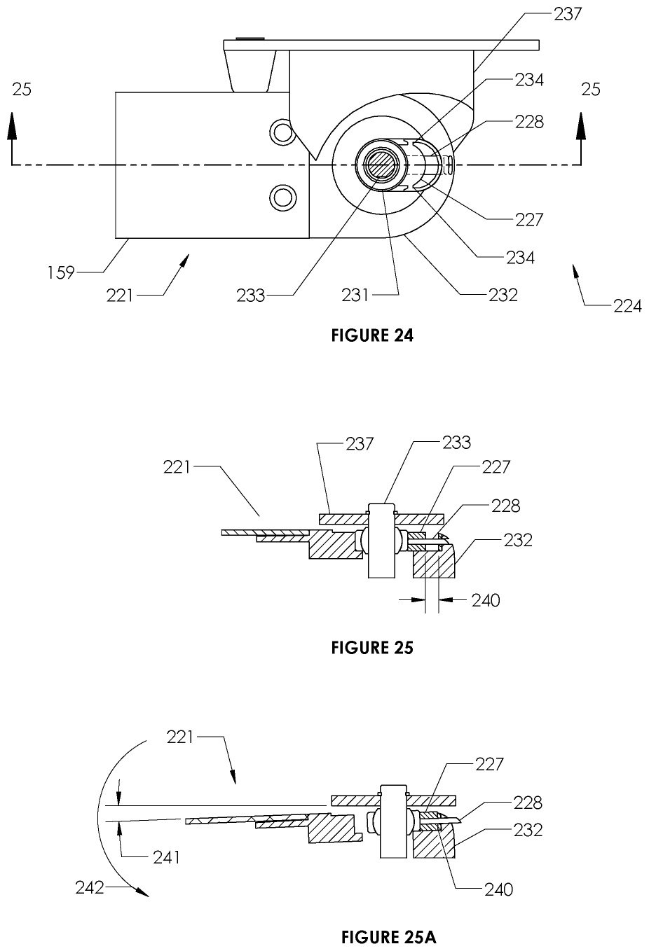

FIG. 25A is the same section as FIG. 25, but shown in an overloaded state. Referring also to FIGS. 24 and 26, shear webs 234 of shearfitting 227 break when bending moment in the direction of arrow 242 applied to arm 221 reaches a predetermined range of magnitude. Gap 240 then reduces to zero thus arm 221 and fitting 232 rotate in the vertical midplane of extrusion 159 to angle 241 and indicator 228 protrudes from fitting 232. Shear fitting 227 may be made of aluminum or, for example for shorter arms where a lower range of overload moment may be desired, a rigid plastic such as polycarbonate. Indicator 228 may for example be made of red plastic.

FIG. 26 is a perspective view on the shear fitting 227. Shear webs 234 connect outer portion 244 to bearing seat portion 245. Referring also to FIG. 25, indicator 228 is a push fit in slot 246 and a sliding fit in slot 247, allowing indicator 228 to move with bearing seat portion 245 and slide in outer portion 244.

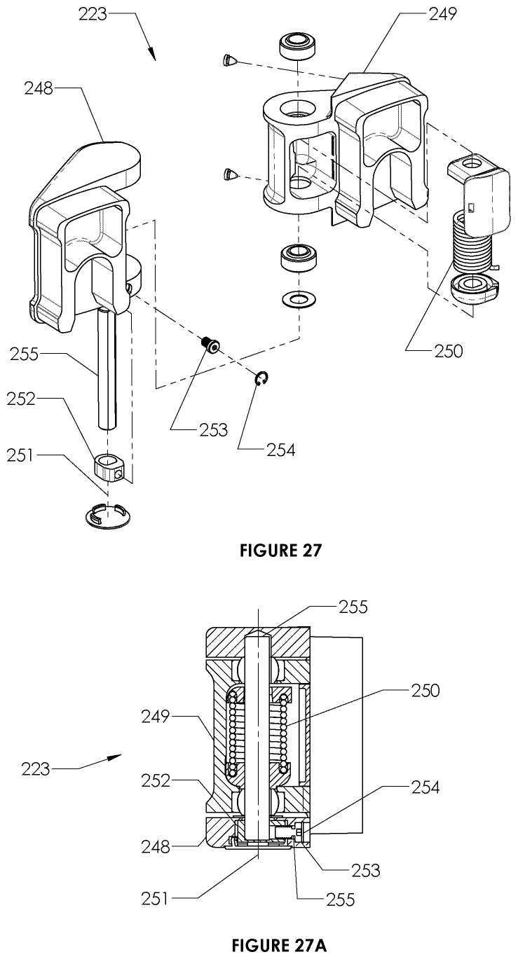

FIG. 27 is an exploded view of elbow joint 223. Outer fitting 248 pivots relative to inner fitting 249 about elbow pivot axis 251 via D-section pivot pin 255. Elbow joint 223 is spring biased towards a stowed position (see FIG. 22) by torsion spring 250, operating in a similar manner to wall pivot joint 244 (see FIG. 23). In a similar manner to another embodiment described in FIG. 17A, elbow adjuster 252 engages adjustment screw 253 which is axially retained to fitting 248 by circlip 254.

FIG. 27A is a section view through elbow joint 223 along the plane through elbow pivot axis 251 and the axis of screw 253, showing outer fitting 248, inner fitting 249, torsion spring 250, elbow pivot axis 251, elbow adjuster 252, screw 253, and circlip 254. Screw 253 has groove 265 designed such that screw 253 breaks in tension at a predetermined tensile load range. Bearing clearance between D-section pivot pin 255 and fitting 248 is sufficient to allow the range of travel of adjuster 252.

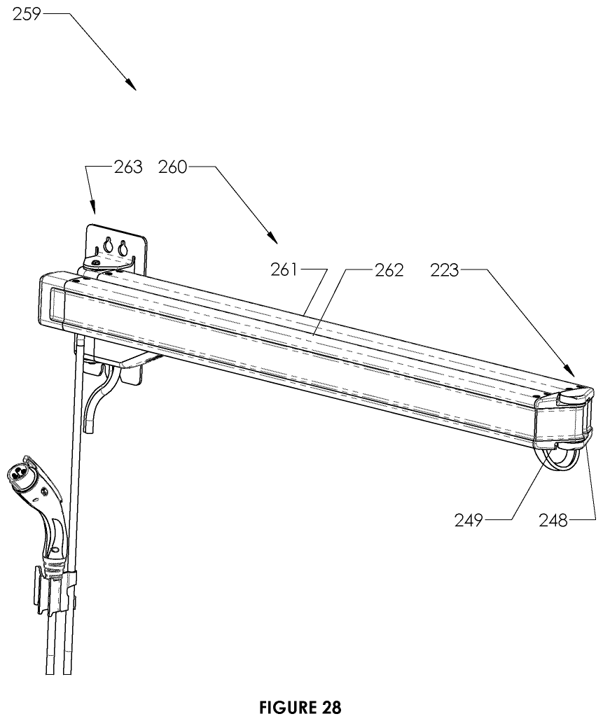

FIG. 28 is a perspective view of another example charging station 259 which is similar to charging station 258, but assembled in a different configuration. Articulated arm 260 includes the same components as arm 220 except as noted below, assembled such that arm 260 stows to the right hand side of a user facing the mounting wall of the station. Elbow joint 223 is identical to that used in arm 220, however in this configuration proximal arm 261 is attached to outer fitting 248 and distal arm 262 is attached to inner fitting 249. Referring also to FIG. 23, right hand stow wall joint 263 is identical to wall pivot joint 224 except torsion spring 229 is replaced by an otherwise identical spring (not shown) wound in the opposite direction.

### Operation—Additional Embodiment Shown in FIGS. 22 Through 28

Operation of the embodiment shown in FIGS. 22 through 28 is similar to that described above for the embodiment shown in FIGS. 1 through 7D, except as follows.

Articulated arm 220 operates in an articulated ‘follow me’ manner, in that when cable 235 is moved a sufficient distance from a free-hanging position, distal arm 222 overcomes bias torque of elbow joint torsion spring 250 and swings out from proximal arm 221. As the user continues to move cable 235 away from wall pivot joint 224, proximal arm 221 swings out from the stowed position overcoming bias torque from spring 229. Upon returning the charge cable 235 to clip 25 and allowing cable 235 to hang free, arms 221 and 222 return to their stowed position. Magnitude of bias torques due to springs 229 and 250 relative to each other may be chosen to provide deployment from the stowed position in a predictable order, distal arm 222 first and then proximal arm 221. Overall magnitude of bias torques due to springs 229 and 250 may be chosen to return arm 220 to the stowed position unassisted, or may be less, requiring the user to lightly assist the return to the stowed position.

In a similar manner to that shown in FIGS. 10A and 17B, if an abuse load of a predetermined range is applied as a downward pull on the free hanging portion of cable 235, breakaway fitting 210 at the distal end (the end opposite elbow 223) of arm 222 pulls out of arm 222.

In a similar manner to that shown in FIGS. 6A, 6B, and FIG. 17A, elbow 223 and wall pivot 224 each have mechanical fuse means providing immediate tactile and audible indication that bending moment in the vertical midplanes of each arm 221 and 222 respectively exceed preselected thresholds, regardless of the positions of arms 221 and 222 within their range of deployment. In the embodiments shown in FIG. 1 through 6B and in FIG. 11 the mechanical fuse means is elastic, whereas in the embodiment shown in FIGS. 22 through 28 the mechanical fuse means are plastic. The threshold of bending moment in distal arm 222 may be selected to be within the elastic torsion limits of proximal arm 221 to help prevent damage when distal arm 222 is loaded while in a partially deployed position near 90 degrees to proximal arm 221. Although not shown in this particular embodiment, one ordinarily skilled in the art will recognize that limit switch 53 as described above for some embodiments may be optionally and readily adapted to the embodiment shown in FIGS. 22 through 28 at elbow joint 223 and/or wall pivotjoint 224, communicating to EVSE 225 via low voltage cable 243.

Referring particularly to FIGS. 27, 27A and 28, when elbow joint 223 is assembled to right-hand stow configured arm 260, adjustment screw 253 is in tension when downward bending moment is applied to distal arm 262. The material of screw 253 along with the dimensions of groove 265 are selected such that screw 253 breaks when downward bending moment applied to distal arm 262 reaches a predetermined range.

The cable breakaway and mechanical fuse features described may, for example, be designed according to the following non-limiting example. Arms 221 and 222 may both be about 48 inches (122 cm) long. Breakaway fitting 210 may pull out of the distal end of arm 222 at a downward pull on cable 235 of 30 to 40 pounds-force (13 to 18 kg force) or more. An abuse load may be defined as a force acting downwards on the distal end (the end opposite elbow 223) of arm 222. Circlip 254 may shear (and screw 253 may break in tension, in the configuration shown in FIG. 28) when the abuse load of 50 to 60 pounds-force (about 23 to 28 kg-force) at any amount of deployment of elbow 223, causing arm 222 to tilt downwards by about 2 degrees. Shear fitting 227 may shear at an abuse load of 150 pounds-force (about 70 kg-force) when elbow 223 is at maximum deployment (see FIG. 22A) and arm 221 is at any position in the deployment range of wall pivot 224, causing arm 221 to tilt down by about 5 degrees. Thus when the abuse load is in the range of 50 to 60 lbsf (about 23 to 28 kg-force) both mechanical fuses in elbow 223 and wall pivot 224 are in an overloaded state, causing the distal end of arm 222 to have moved downwards by about 12 inches or about 30 cm. In this example the recommended clearance from the underside of arm 220 to the tallest vehicle recommended to be parked under arm 220 may be 40 cm. The load required to permanently deform bracket 237 at any position in the deployment range of wall pivot 224 may be selected to be equivalent to 175 pounds-force abuse load or more. The attachment of bracket 237 to a structure may be designed to withstand an abuse load of 200 lbsf (90 kgf) at any position in the deployment range of wall pivot 224.

In a similar manner to the embodiment described in FIG. 17A, turning elbow adjustment screw 253 changes the angle of distal arm 222 relative to proximal arm 221 may be used as required to compensate for sag and tolerances to ensure the proximal and distal arms 221 and 222 are at the same level to horizontal. This operation applies similarly to the right hand configuration 260, where proximal arm 261 is attached to outer elbow fitting 248 and distal arm 262 is attached to inner elbow fitting 249.

In the embodiment shown in FIGS. 22 through 28, indicator light and sensor unit 161 operates as described above for sensor 127 and light 128 in the embodiment shown in FIGS. 1 through 7D. Additionally, the indicator light and sensor unit 161 on distal arm 222 may gather sensing data in the volume below the end of distal arm 222, while indicator light and sensor unit 161 in proximal arm 221 may gather sensing data in the volume projecting outward and downward from wall pivot joint 224, so that when stowed as shown in FIG. 22, sensing range is extended in different directions and the indicator light portions can be seen from different directions. Thus sensing and indication functions cover a larger area and can function at a wider variety of relative positions between the vehicle and the charging station. For example when stowed as shown in FIG. 22, a vehicle could approach from either direction roughly parallel to the stowed arms 221 and 222. Since arms 221 and 222 move relative to one another with a single degree of freedom about elbow pivot axis 251, and are each located a known constant pose relative to elbow axis 251, data from units 161 in each of arms 221 and 222 may be combined to enhance the functionality described above, for example by stitching images together.

### Advantages

From the description above, a number of advantages of some embodiments of the charging station become evident, some of which are particularly, but not exclusively, adapted to residential use. The charging station may, for example have any combination of the following features:
a) Provides means for a charging cable and plug to reach a wide range of locations above a parking space relative to available mounting structures and power source locations, with the cable held off the ground;
b) Protects and hides significant portions of power supply and charge cables by providing an enclosed conduit;
c) Limits downward tension loads applied to a charging cable;
d) Provides tactile, audible, and persisting visual indication that excessive load has been applied to part of the charging station structure, at a load range selected to be below the level likely to cause permanent damage to the charging station or its mountings, and may interrupt power supply to the cable in the event of such excessive load;
e) Deploys to the desired location without motive power from the station or significant force applied by the user to the cable;
f) Returns to a stowed position with the plug and charging cable off the ground, without the user having to apply significant force to the station or manually coil the cable;
g) Provides means for the user to stow the charging plug end of the charging cable on the movable portion of the station near the position it is used,
h) Integrates the EVSE with the movable portion of the charging station, eliminating the need for remote attachment of the EVSE to surrounding structure and maximizing the range of reach for a given charge cable length.
i) Provides for optional expansion of the charging station from an initial installation of one charging circuit to two charging circuits after initial installation, without complete replacement of the EVSE.
j) Provides sensing, security camera, and lighting functions.
   It is not mandatory that any individual embodiment of the present technology provides any of the above advantages.

Charging stations as described herein may be developed and adapted for residential use and may provide the ability to position a charging cable overhead over the majority of the area of the parking space (thereby keeping the charging cable off the ground), provide progressive warning to the user of excess load being applied to the cable or the structure of the station, and provide indication that persists after such loads are released that an overload has occurred, without excess mechanical complexity or weight.

Although the description above contains specificities, these should not be construed as limiting the scope of the embodiments but as merely providing illustrations of some of several embodiments. For example, the mechanical fusible links shown could have other shapes, materials, or attachment means that provide elastic or non-elastic limits to motion into the overload indicating condition. Mounting structure could be provided with the station, for example as a pedestal or post mounted to the ground near a parking space. Arm structures could have various forms without a single planar midplane, but still have a rotation plane passing through a distal load application point and a pivot axis, in which moments due to abuse loads lie and which follows the motion of the arm throughout its deployment range.

Where a component (e.g. a joint, plug, sensor, controller, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Electronic controllers in some embodiments of the invention are implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

### Interpretation of Terms

Unless the context clearly requires otherwise, throughout the description and the
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1-61. (canceled)

62. A cable assembly useful for electric vehicle charging, the cable assembly comprising:
an arm;
a mount configured to attach the arm to a structure such that the arm projects outwardly from the mount; and
a cable supported by the arm and having a free end extending from a distal end of the arm, the cable releasably being attached to the arm by a force limiting mechanism, the force limiting mechanism operative to allow the cable to be separated from the arm in response to tension pulling the cable in a direction such that a force component in a direction transverse to the arm has a magnitude exceeding a threshold.

63. The cable assembly according to claim 62, wherein the force limiting mechanism deforms elastically.

64. The cable assembly according to claim 62, wherein the arm is formed with a longitudinally extending channel that has an opening facing outwardly of the arm, wherein the cable extends along the channel, and wherein the force limiting mechanism includes one or more members that block the cable from being pulled out of the channel through the opening.

65. The cable assembly according to claim 64, wherein the force limiting mechanism includes an elongated panel that covers the opening of the channel and wherein one or more of: i) the panel is held to the arm by push-in rivets spaced apart along a length of the channel; and ii) the panel includes laterally-projecting flexible tab portions, the channel includes first and second recesses on opposing sides of the channel and the panel is held to the arm by engagement of the flexible tabs of the panel with the recesses on the opposing sides of the channel.

66. The cable assembly according to claim 62, wherein the force limiting mechanism includes a breakaway conduit attached to the arm by one or more releasable fasteners configured to allow the breakaway conduit to pull away from the arm in response to the force component acting on the breakaway conduit.

67. The cable assembly according to claim 62, wherein the arm is coupled to the mount by a coupling that includes a mechanical fuse, the mechanical fuse being configured to deform or break to allow the distal end of the arm to drop to a dropped position in response to a moment caused by downward force on the arm exceeding a threshold moment, with the arm remaining in the dropped position until the mechanical fuse is reset or replaced.

68. The cable assembly according to claim 67, wherein the mechanical fuse is configured to enable the arm to move from a first position to a second position angled relative to the first position.

69. The cable assembly according to claim 67, wherein the coupling includes an adjuster configured to enable the arm to move from a first position to a second position angled relative to the first position.

70. The cable assembly according to claim 62, wherein the mount includes a wall bracket with one or more bend relief slots, with the bracket being configured to permanently deform at a predetermined range of load.

71. The cable assembly according to claim 62, wherein the arm is coupled to the mount by a pivot assembly configured to allow the arm to pivot about a substantially vertical axis.

72. The cable assembly according to claim 71, including one or more of: wherein the pivot assembly includes a bias mechanism connected to bias the arm toward a stowed position; and wherein the pivot assembly includes a detent mechanism configured to resist movement of the arm away from one or more selected positions.

73. The cable assembly according to claim 72, wherein the detent mechanism comprises:
a circular detent plate having a plurality of radial grooves formed thereon; and
a spring ball plunger, the spring ball plunger selectively engageable with said radial grooves.

74. The cable assembly according to claim 71, wherein the pivot assembly includes a mechanical fuse, the mechanical fuse being configured to deform or break to allow a pivot axis of the pivot assembly to shift from a normal vertical orientation to an inclined orientation in response to a moment caused by downward force on the arm exceeding a threshold moment, and wherein the pivot assembly is configured so that the pivot axis remains at the inclined orientation until the mechanical fuse is reset or replaced.

75. The cable assembly according to claim 74, wherein the pivot assembly includes first and second spaced apart bearings that define the pivot axis, wherein the mechanical fuse holds the first bearing in a position such that the pivot axis is vertical and wherein deformation or breaking of the mechanical fuse allows transverse movement of the first bearing relative to the second bearing such that the pivot axis is movable to an angle that is inclined to vertical.

76. The cable assembly according to claim 75, wherein the first bearing is slidable along a slot that extends transversely relative to the pivot axis and wherein the mechanical fuse includes a member that blocks the first bearing from sliding along the slot until a force reacting to the threshold moment on the mechanical fuse exceeds a threshold.

77. The cable assembly according to claim 71, including a mechanical fuse, the mechanical fuse being configured to deform or break to allow an angle of the arm relative to a pivot axis of the pivot assembly to shift downward from a normal orientation to a changed orientation in which the distal end of the arm is in a lowered inclined orientation in response to a moment caused by downward force on the arm exceeding a threshold moment.

78. The cable assembly according to claim 77, wherein the mechanical fuse is located between a bearing of the pivot assembly and a support member on the arm and the mechanical fuse is in a line of force transmission between the support member and the bearing, and i) wherein the mechanical fuse is normally in compression and is configured to be reduced in length upon being deformed or broken or ii) wherein the mechanical fuse is normally in tension and is configured to be increased in length upon being deformed or broken or iii) wherein the mechanical fuse is normally in shear and is configured to shear partially or fully upon being deformed or broken.

79. The cable assembly according to claim 77, wherein the mechanical fuse is configured to be variable in length to allow the angle of the arm relative to the pivot axis to be adjusted within a selected range.

80. The cable assembly according to claim 62, wherein the arm includes at least one intermediate pivot joint configured to allow a distal portion of the arm to be pivoted relative to a proximal portion of the arm about a substantially vertical intermediate axis.

81. The cable assembly according to claim 80, wherein the intermediate pivot joint includes a mechanical fuse, the mechanical fuse being configured to deform or break to allow the distal portion of the arm to move to a dropped position in response to a moment caused by downward force on the distal portion of the arm, with the distal portion of the arm remaining in the dropped position until the distal portion of the mechanical fuse is reset or replaced.

82. The cable assembly according to claim 81, wherein the mechanical fuse is configured to allow the angle between the distal portion of the arm and the horizontal plane to be adjusted within a selected range.

83. The cable assembly according to claim 62, including a charging plug support to which the cable slidably couples, wherein the charging plug support includes a cradle configured to receive and support a plug; and wherein one or more of
i) the charging plug support includes a hook dimensioned to receive and support one or more loops of the cable;
ii) the charging plug support includes a cable receiving portion comprising a plurality of elements that define a bent path for the cable through the cable receiving portion; and
iii) the charging plug support includes a cable receiving portion that includes a plurality of elastic elements which deflect when engaging the cable.

84. The cable assembly according to claim 83, wherein the cable receiving portion is one or more of shaped and configured such that friction between the cable and the cable receiving portion resists one or more of a weight of the plug received in the cradle and a weight of the one or more loops of the cable supported by the hook.

85. An electric vehicle charging station comprising:
an electrical power supply cable,
a control unit connectable to receive electrical power from the electrical power supply cable,
a charging plug adapted to connect to an electric vehicle,
a charging cable having a proximal end connected to the control unit and a distal end connected to the charging plug,
a base portion mountable to a structure,
an arm projecting from the base portion, the arm having a proximal end coupled to the base portion and a distal end spaced apart from the base portion, the arm including one or more force-limiting attachments for supporting at least a portion of the charging cable, wherein the one or more force-limiting attachments are configured to separate from the arm if the cable or the one or more force-limiting attachments are pulled away from the arm by a force exceeding a threshold force, and
the electric vehicle charging station further comprising one or more of:
a) a connection of the arm to the base portion configured to suddenly allow the distal end of the arm to drop from a first position to a dropped position that is lower relative to the first position in response to a moment about the base portion that is directed to move the distal end of the arm downward, with the distal end of the arm remaining at the dropped position until the connection is reset;
b) a sensor coupled to the arm and adapted to generate a signal in response to motion in a vicinity of the control unit, the control unit including a communication means for communicating one or more of state and fault conditions of the control unit and the signal of the sensor to a user;
c) a charging plug support means slidably coupled to a free end of the charging cable between the distal end of the arm and the charging plug, wherein the charging plug support means includes a cable receiving portion engaging the charging cable, a cradle portion adapted to support the charging plug and a hook portion adapted to support a portion of the charging cable;
d) the control unit is attached to and supported by the arm;
e) the control unit includes a primary charging circuit controller and a plurality of receptacles adapted to connect a secondary charging circuit controller to the primary charging circuit controller within the control unit.

86. The electric vehicle charging station according to claim 85, wherein the arm includes a proximal arm section connected to a distal arm section by a pivot joint defining a pivot axis.

87. The electric vehicle charging station according to claim 86, where the pivot joint includes a mechanical fuse, the mechanical fuse being configured to deform or break to allow the distal portion of the arm to move to a dropped position in response to a moment caused by downward force on the distal portion of the arm, with the distal portion of the arm remaining in the dropped position until the distal portion of the mechanical fuse is reset or replaced.

88. A cable support assembly useful for electric vehicle charging, the cable support assembly comprising:
an arm;
a mount configured to attach the arm to a structure such that the arm projects outwardly from the mount; and
a force limiting mechanism configured to enable a cable to releasably couple to the arm, the force limiting mechanism being operative to allow the cable to be separated from the arm in response to tension pulling the cable in a direction such that a force component in a direction transverse to the arm has a magnitude exceeding a threshold.

89. The cable support assembly according to claim 88, the cable support assembly further comprising one or more of:
a) a connection of the arm to the mount configured to suddenly allow the arm to drop from a first position to a downward inclined position that is angled relative to the first position in response to a moment about the connection that is directed to move the arm downward, with the arm remaining at the downward inclined position until the connection is reset;
b) a connection of the mount to the structure configured to allow the arm to drop from a first position to a downward inclined position that is angled relative to the first position in response to a moment about the connection that is directed to move the arm downward, with the arm remaining at the downward inclined position until the connection is reset; and
c) wherein the cable includes a hanging portion extending from a distal location of the arm and terminating in a charging plug, and the cable support assembly includes charging plug support means adapted to be slidably coupled to the hanging portion, wherein the charging plug support means includes a cable receiving portion engaging the hanging portion, a cradle portion adapted to support the charging plug, and a hook portion adapted to support one or more loops of the hanging portion of the charging plug support means.

90. The cable support assembly according to claim 88, wherein the arm includes at least one intermediate pivot joint configured to allow a distal portion of the arm to be pivoted relative to a proximal portion of the arm.

91. The cable support assembly according to claim 90, wherein the at least one intermediate pivot joint includes a mechanical fuse configured to perform one or more of:
a) allowing the angle between the distal portion of the arm and the horizontal plane to be adjusted within a selected range; and
b) deforming or breaking to allow the distal portion of the arm to move to a dropped position in response to a moment caused by downward force on the distal portion of the arm, with the distal portion of the arm remaining in the dropped position until the distal portion of the mechanical fuse is reset or replaced.

92. The cable support assembly according to claim 88, wherein the cable is a charging cable for an electric vehicle and wherein the cable support assembly further includes a control unit attached to the arm and connectable to the charging cable, the control unit connectable to receive electrical power from an electrical power supply cable.

93. The cable support assembly according to claim 92, wherein the cable support assembly further comprises one or more of:
a) a sensor coupled to the arm and adapted to generate a signal in response to motion in a vicinity of the control unit, the control unit including a communication means for communicating one or more of state and fault conditions of the control unit and the signal of the sensor to a user; and
b) the control unit including a primary charging circuit controller and a plurality of receptacles adapted to connect a secondary charging circuit controller to the primary charging circuit controller within the control unit.
